(19) United States
(12) Patent Application Publication
(10) Pub. No.: US 2025/0110336 A1
(43) Pub. Date: Apr. 3, 2025

(54) SYSTEMS AND METHODS OF CONTROLLING THE OUTPUT OF LIGHT

(71) Applicant: Apple Inc., Cupertino, CA (US)

(72) Inventors: Jean-Pierre M. MOUILLESEAUX, San Carlos, CA (US); Samantha K. RAJA, San Francisco, CA (US); Karlin Y. BARK, San Carlos, CA (US)

(21) Appl. No.: 18/900,721

(22) Filed: Sep. 28, 2024

Related U.S. Application Data
(60) Provisional application No. 63/587,052, filed on Sep. 29, 2023.

(51) Int. Cl. G02B 27/01; G01J 1/42; G02B 27/00; G02B 27/18; G06F 1/16

(52) U.S. Cl. CPC G02B 27/0101; G01J 1/4204; G02B 27/0093; G02B 27/017; G02B 27/18; G06F 1/163; G02B 2027/0134; G02B 2027/0141; G02B 2027/0174; G02B 2027/0178

(57) ABSTRACT

Some embodiments described in this disclosure are directed to an electronic device controlling one or more objects within and/or integrated with the platform in response to a change in the environment external to the interior of the platform and/or a change in the interior of the platform. In some embodiments, the electronic device adjusts the output of light from the one or more light sources within the interior of the platform in response to the change in ambient light within the interior of the platform. In some embodiments, the electronic device displays or causes to display the visual indication of one or more environmental factors of the environment external to the interior of the platform.

### CROSS-REFERENCE TO RELATED APPLICATIONS

This application claims the benefit of U.S. Provisional Application No. 63/587,052, filed Sep. 29, 2023, the content of which is herein incorporated by reference in its entirety for all purposes.

### FIELD

The present disclosure relates generally to computer user interfaces, and more specifically to techniques for controlling the output of light from one or more light sources.

### BACKGROUND

Electronic devices often control the output of light in the environment. Such manipulation of one or more light sources and/or objects preserve user privacy.

### SUMMARY

Some techniques for controlling one or more objects within and/or integrated with a platform in response to a change in the environment external to the interior of the platform and/or a change in the interior of the platform using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for controlling one or more objects within and/or integrated with a platform in response to a change in the environment external to the interior of the platform and/or a change in the interior of the platform. Such methods and interfaces optionally complement or replace other methods for controlling one or more objects within and/or integrated with a platform in response to a change in the environment external to the interior of the platform and/or a change in the interior of the platform. Such methods and interfaces reduce the cognitive burden on a user and produce a more efficient human-machine interface. For battery-operated computing devices, such methods and interfaces conserve power and increase the time between battery charges.

There is a need for an electronic device to control the output of light from one or more light sources within an interior of a platform in response to a change in ambient light within the interior of the platform. In some embodiments, the electronic device is in communication with the platform. In some embodiments, the electronic device detects a change to ambient light within the interior of the platform. In some embodiments, in response to detecting the change to the ambient light within the interior of the platform, the electronic device adjusts the output of light in the interior of the platform in a manner that is based at least in part on a determination that the change to the ambient light within the interior of the platform is caused by a change in a light source in an environment external to the interior of the platform or a light source within the interior of the platform. Adjusting the output of light from the one or more light sources within the interior of the platform in response to a change in ambient light within the interior of the platform enables a user to view information and operate devices in an environment with changing ambient lighting conditions.

There is also a need for an electronic device to display a visual indication of one or more environmental factors of the environment of the platform in response to a change in the environment external to the interior of the platform. In some embodiments, the electronic device is in communication with a display component included in the platform. In some embodiments, while the display component is operating in a first mode, the electronic device facilitates an environment of the platform that includes one or more environmental factors of the environment to be visible to the interior of the platform. In some embodiments, in response to detecting data indicative of a request for the display component to operate according to a second mode, different from the first mode, the electronic device displays, via the display component, a visual indication of the one or more environmental factors of the environment. Displaying a visual indication of the one or more environmental factors of the environment of the platform enables a user to view information about the environment while also providing the user with privacy, thereby preserving user privacy while reducing potential disorientation of the user being unable to determine their spatial position in the environment.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for controlling one or more objects within and/or integrated with a platform in response to a change in the environment external to the interior of the platform and/or a change in the interior of the platform, thereby increasing the effectiveness, efficiency, and user satisfaction with such devices. Such methods and interfaces may complement or replace other methods for controlling one or more objects within and/or integrated with a platform in response to a change in the environment external to the interior of the platform and/or a change in the interior of the platform.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5A is a block diagram illustrating an eye tracking unit of a computer system that is configured to capture gaze inputs of the user in accordance with some embodiments.

FIG. 5B is a flow diagram illustrating a glint-assisted gaze tracking pipeline in accordance with some embodiments.

FIG. 5C is a block diagram illustrating a system with various components in accordance with some embodiments.

FIGS. 6A-6P illustrate examples of an electronic device controlling one or more objects within and/or integrated with a platform in response to a change in the environment external to the interior of the platform and/or a change in the interior of the platform in accordance with some embodiments.

FIG. 7 is a flow diagram illustrating a method in which an electronic device controls the output of light from one or more light sources within the interior of the platform in response to a change in ambient light within the interior of the platform in accordance with some embodiments.

FIG. 8 is a flow diagram illustrating a method in which an electronic device displays or causes to display a visual indication of one or more environmental factors of the environment external to the interior of the platform in accordance with some embodiments.

### DETAILED DESCRIPTION

The present disclosure relates to user interfaces for providing an extended reality (XR) experience to a user, in accordance with some embodiments.

The systems, methods, and GUIs described herein improve user interface interactions with virtual/augmented reality environments in multiple ways.

The following description sets forth exemplary techniques for controlling one or more objects within and/or integrated with a platform in response to a change in the environment external to the interior of the platform and/or a change in the interior of the platform. This description is not intended to limit the scope of this disclosure but is instead provided as a description of example implementations.

Users need electronic devices that provide effective techniques for controlling one or more objects within and/or integrated with a platform in response to a change in the environment external to the interior of the platform and/or a change in the interior of the platform. For example, an electronic device can control the output of light from one or more light sources within an interior of a platform in response to a change in ambient light within the interior of the platform. In another example, an electronic device can display a visual indication of one or more environmental factors of the environment of the platform in response to a change in the environment external to the interior of the platform. Efficient techniques can reduce a user's mental load when controlling one or more objects within and/or integrated with a platform. This reduction in mental load can enhance user productivity and make the device easier to use. In some embodiments, the techniques described herein can reduce battery usage and processing time (e.g., by providing user interfaces that require fewer user inputs to operate).

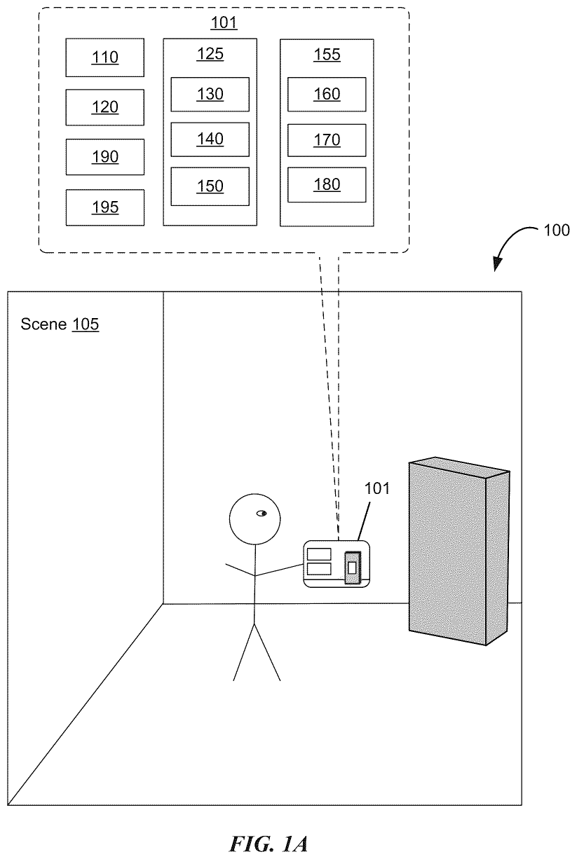

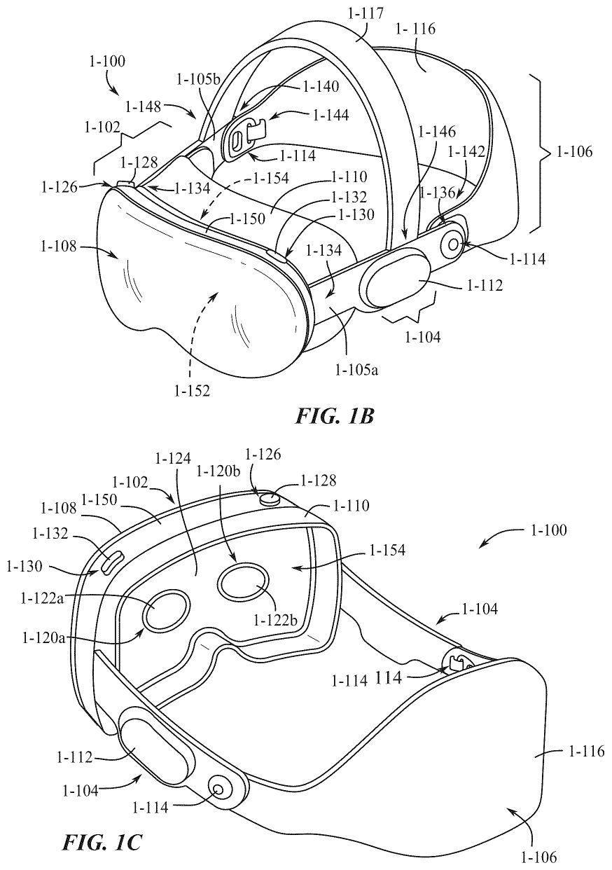

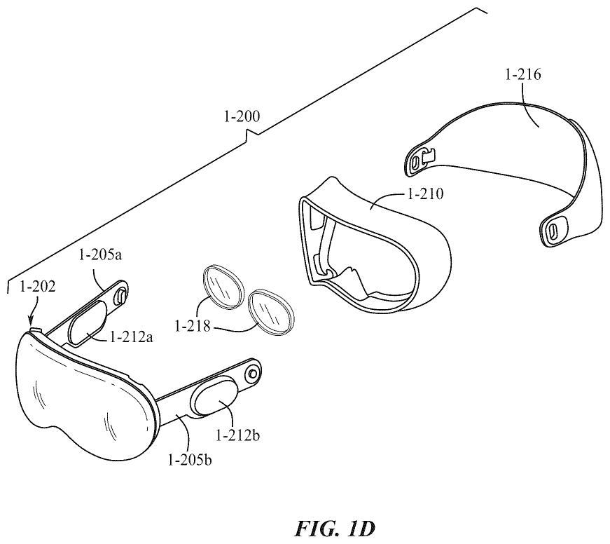

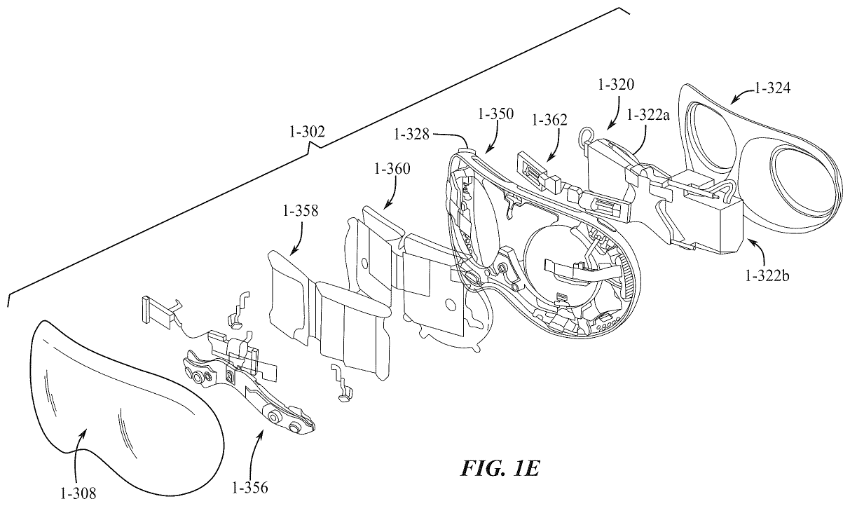

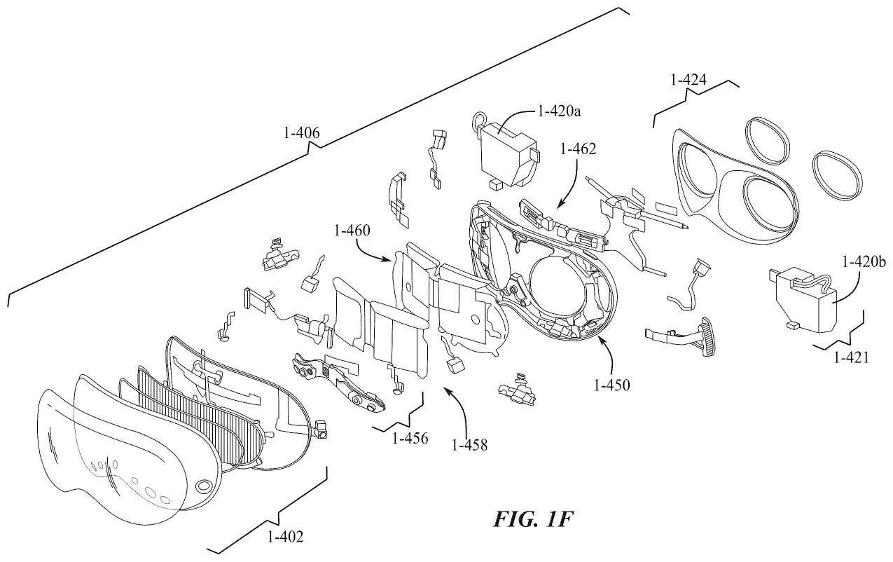

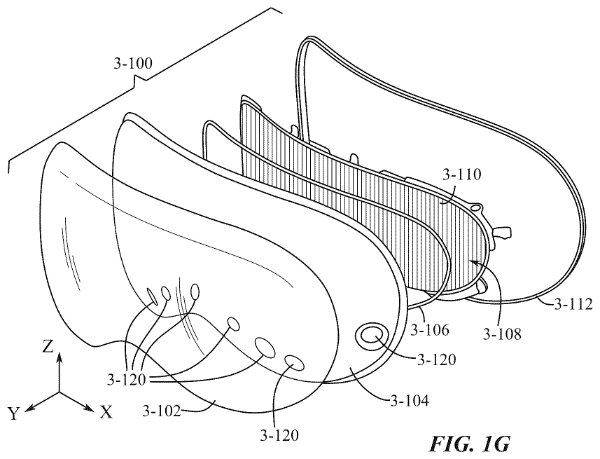

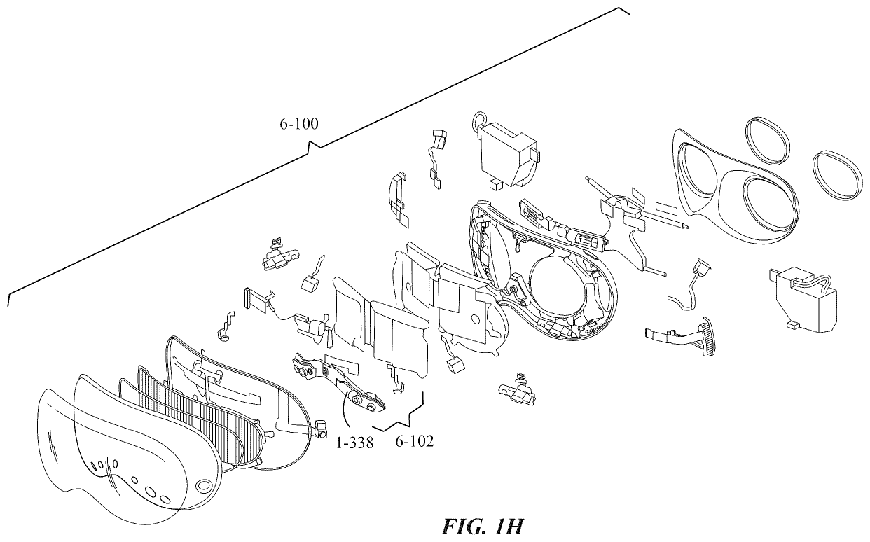

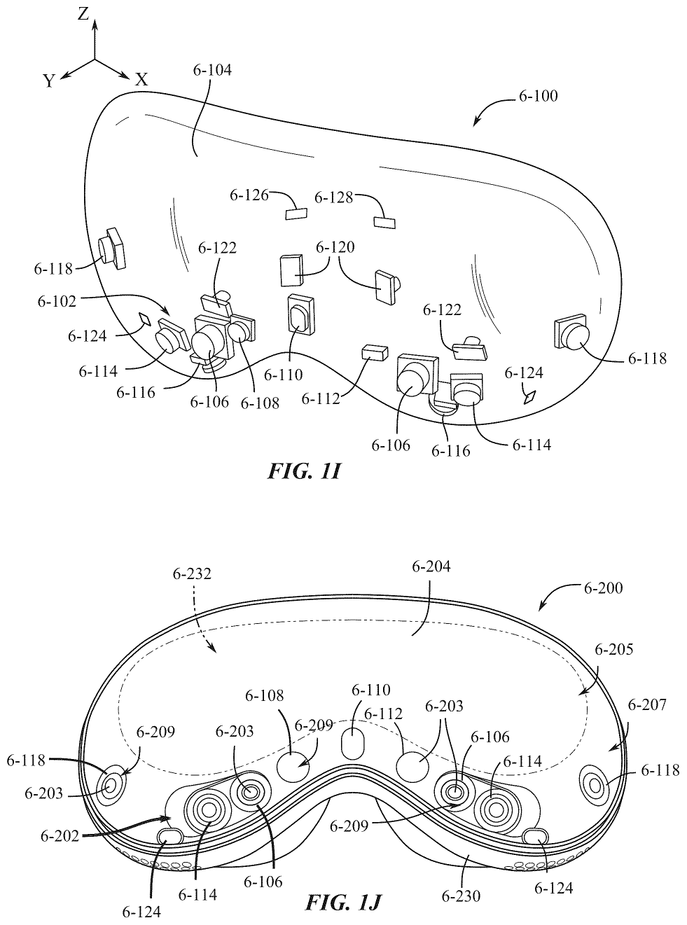

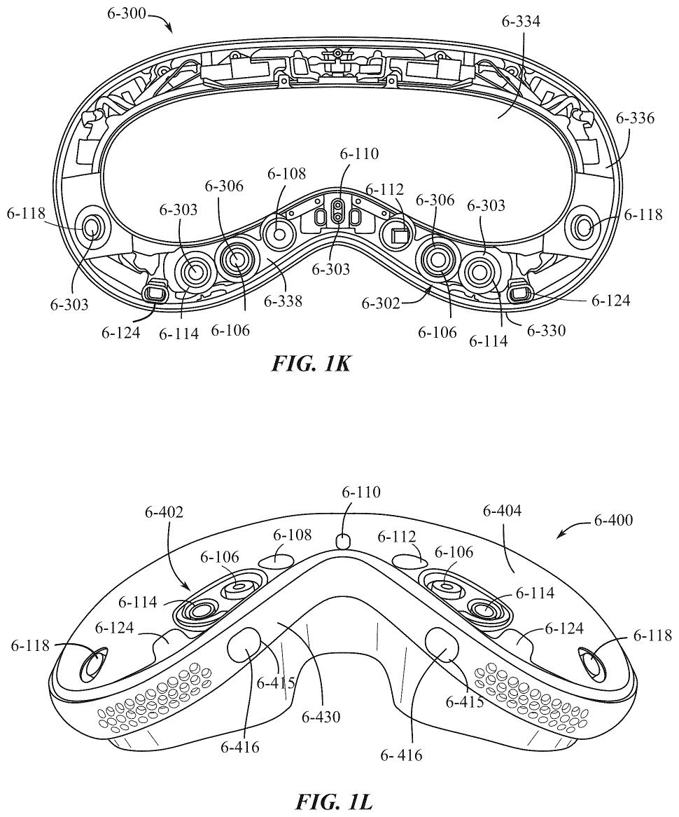

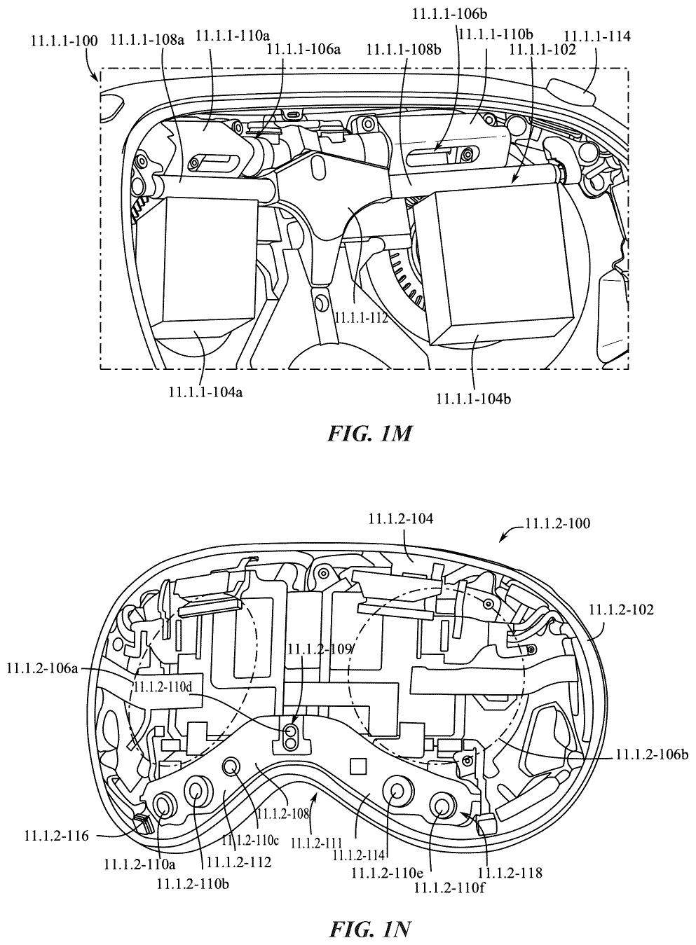

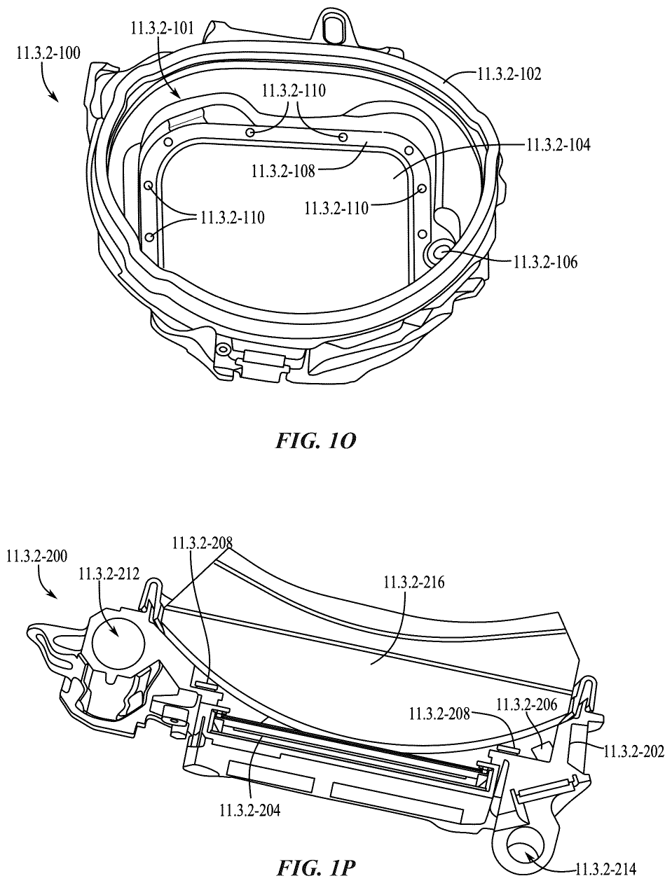

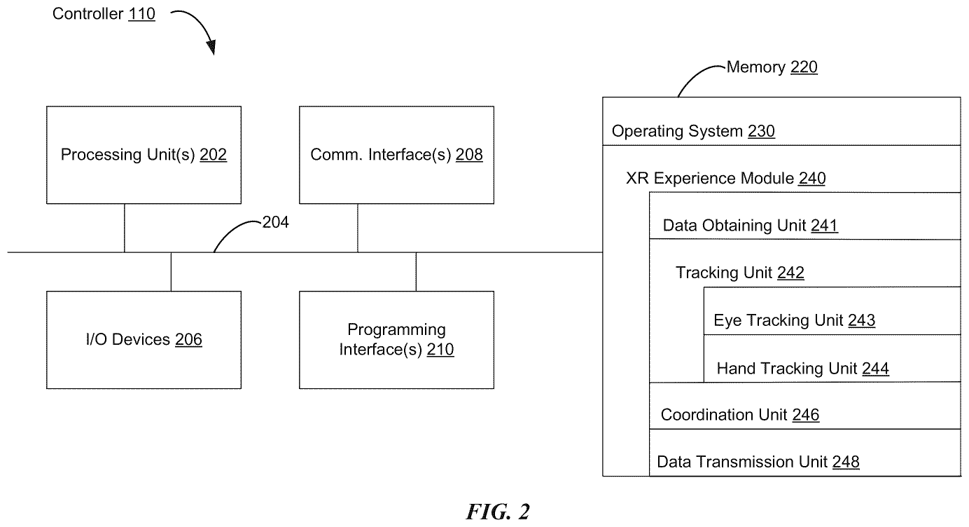

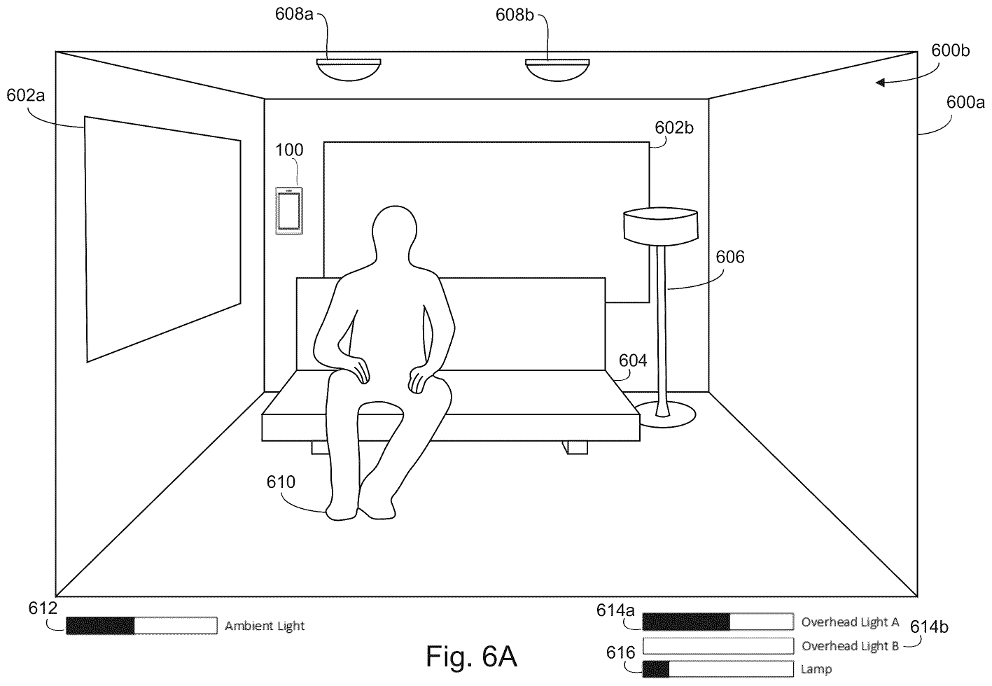

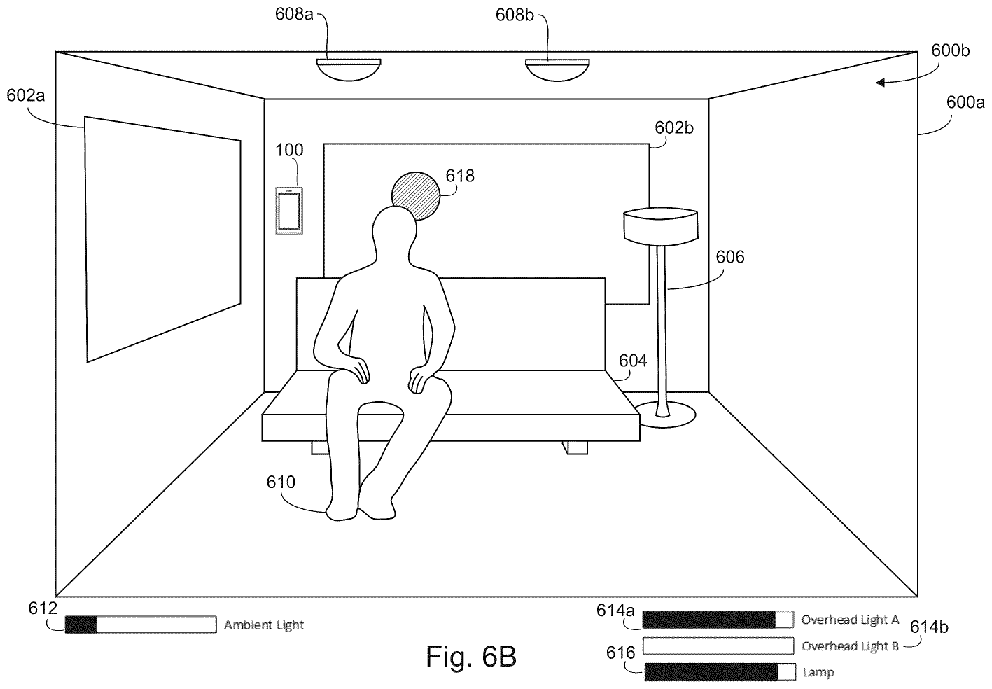

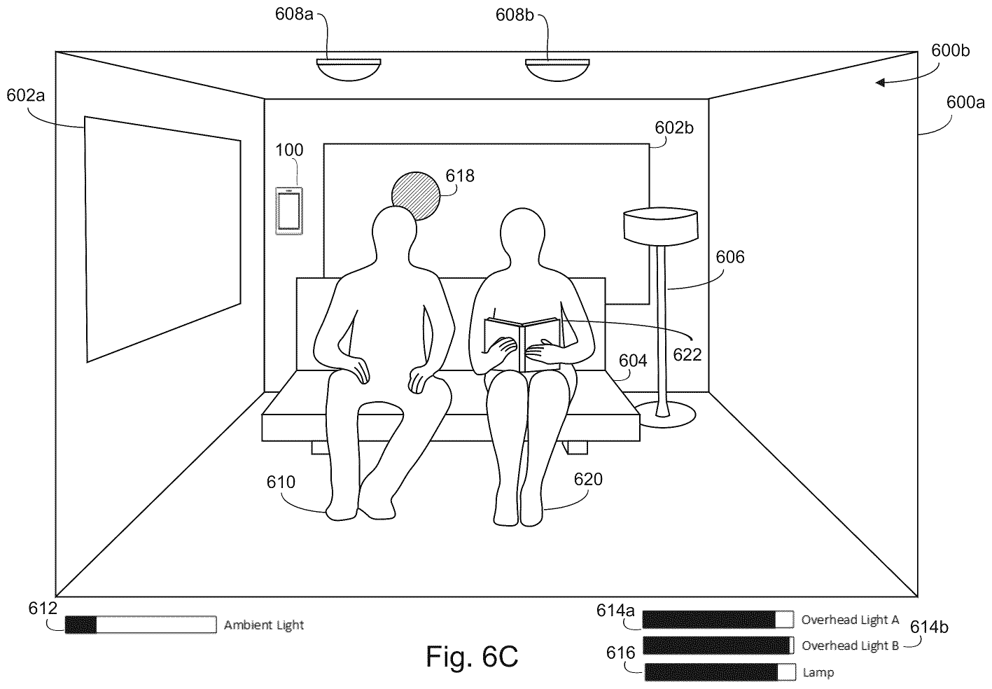

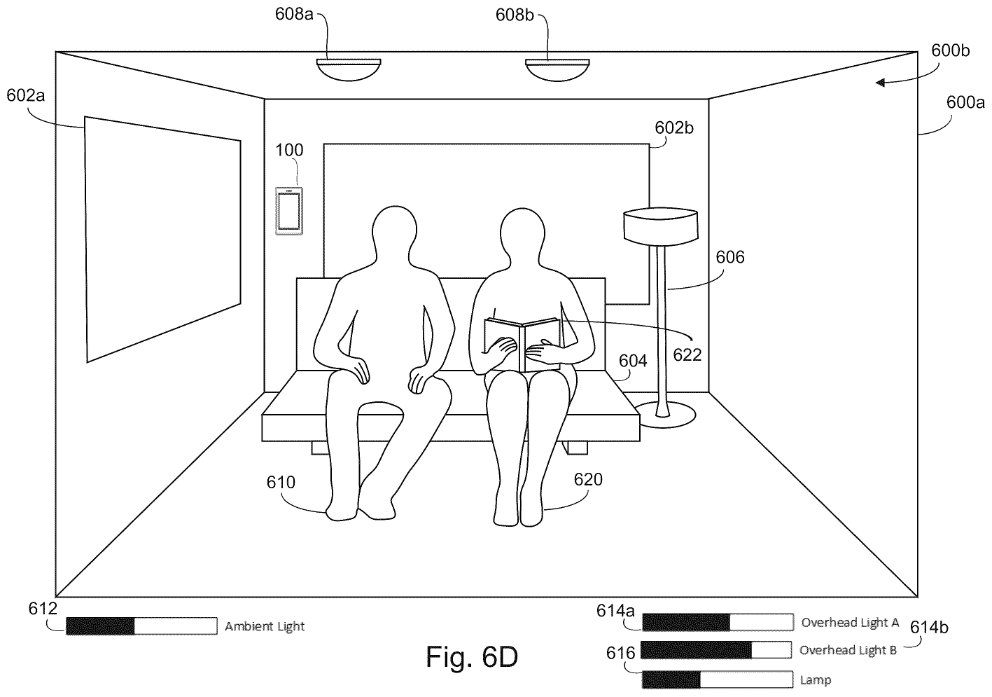

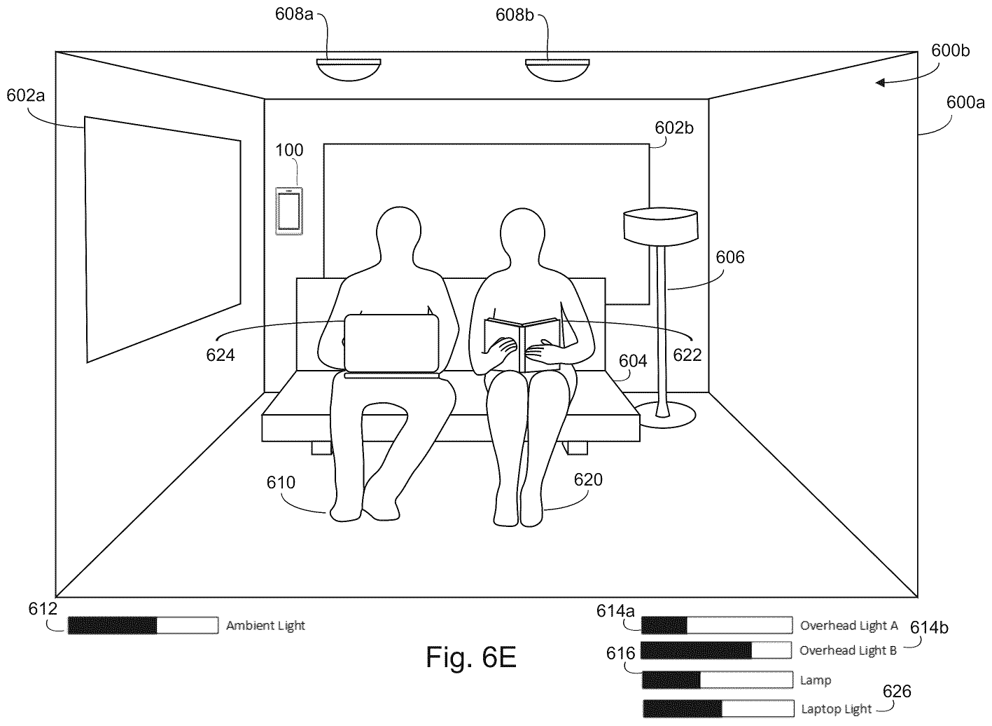

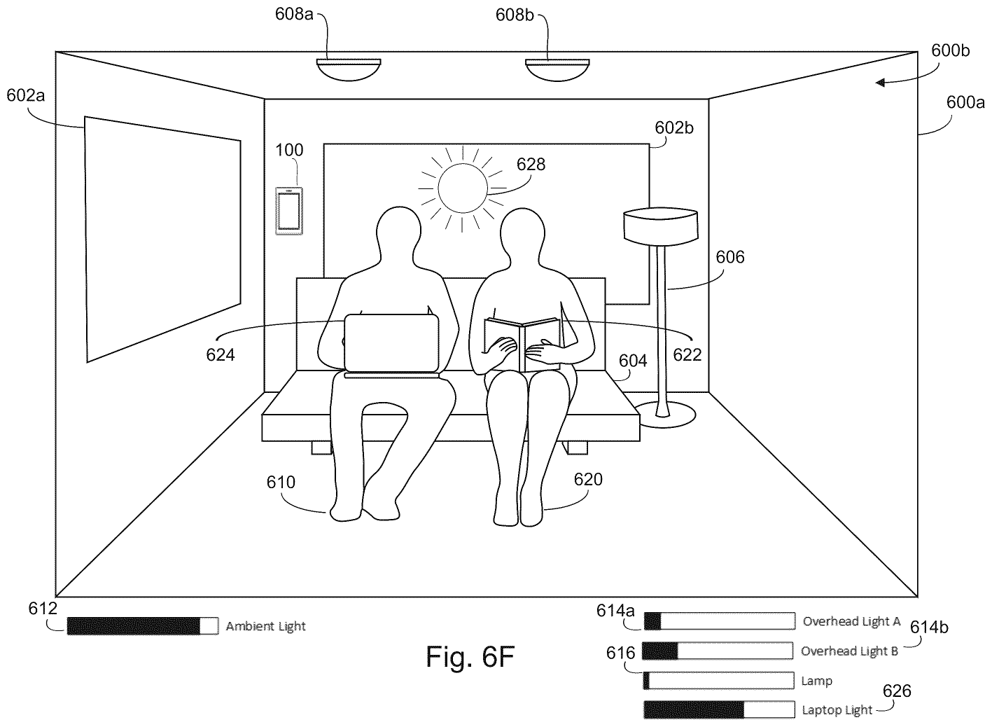

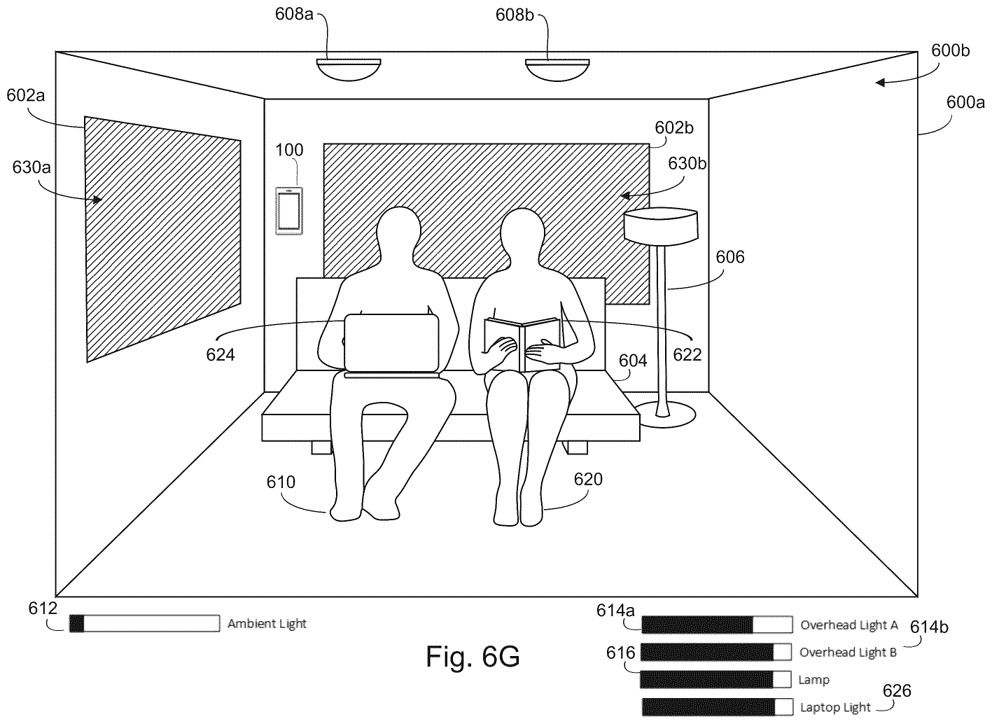

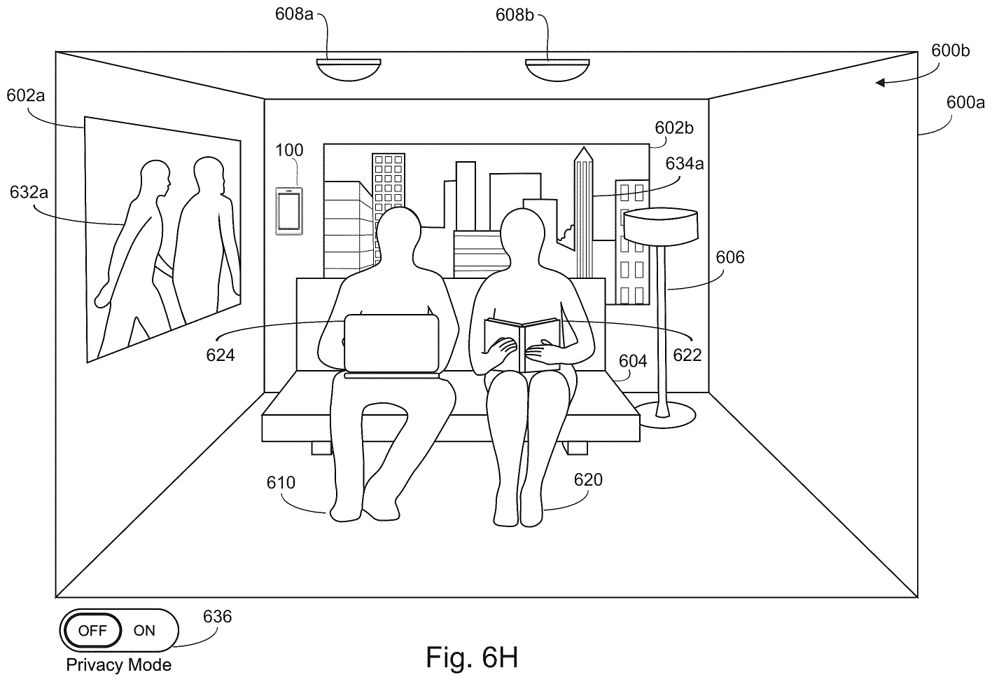

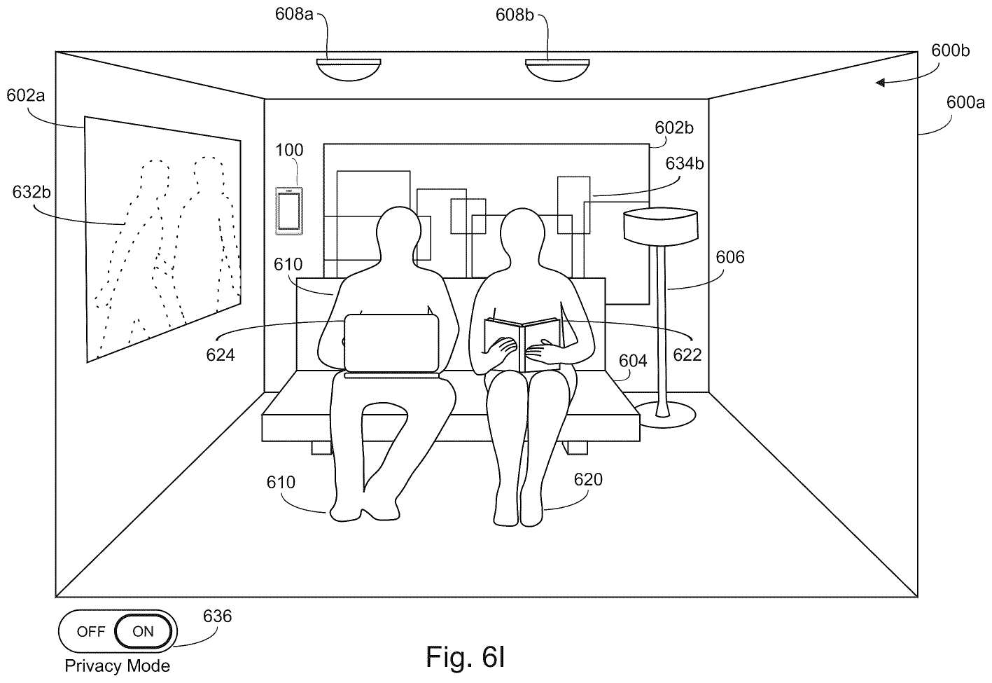

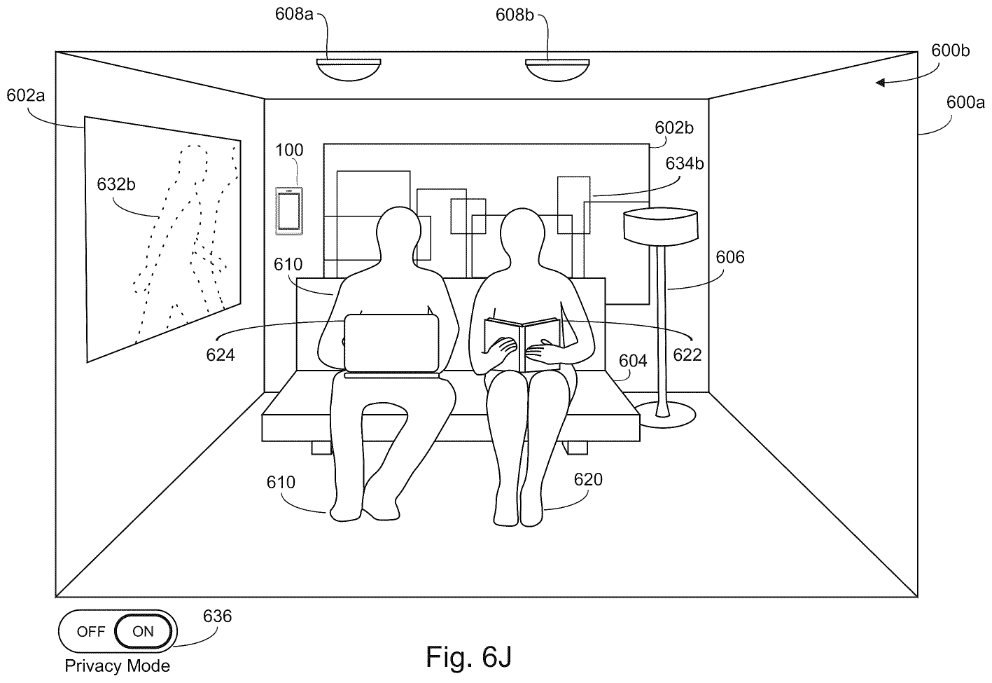

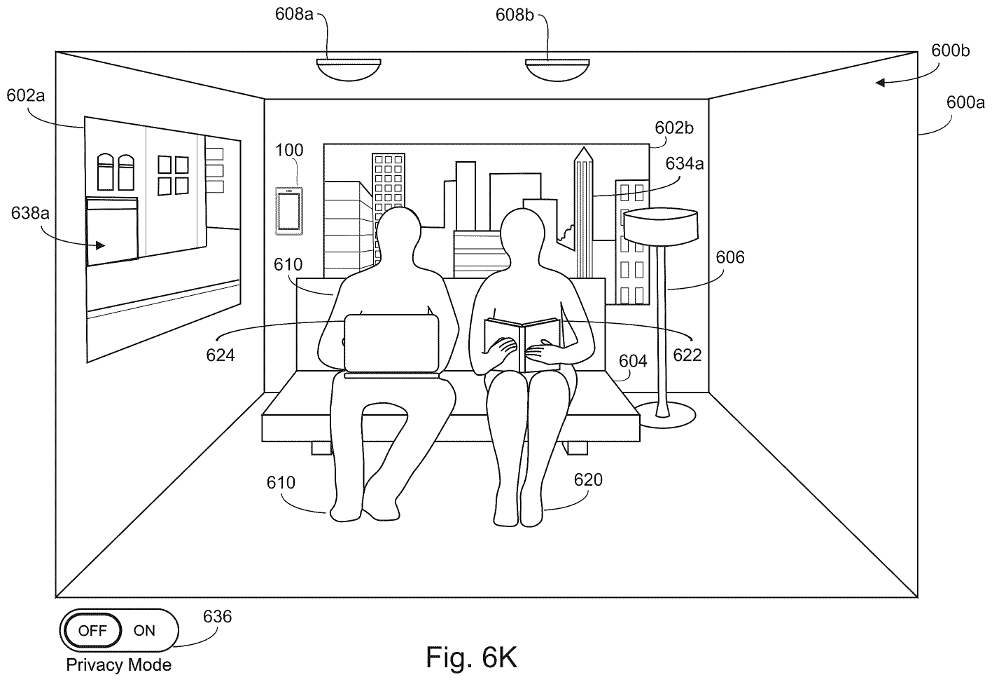

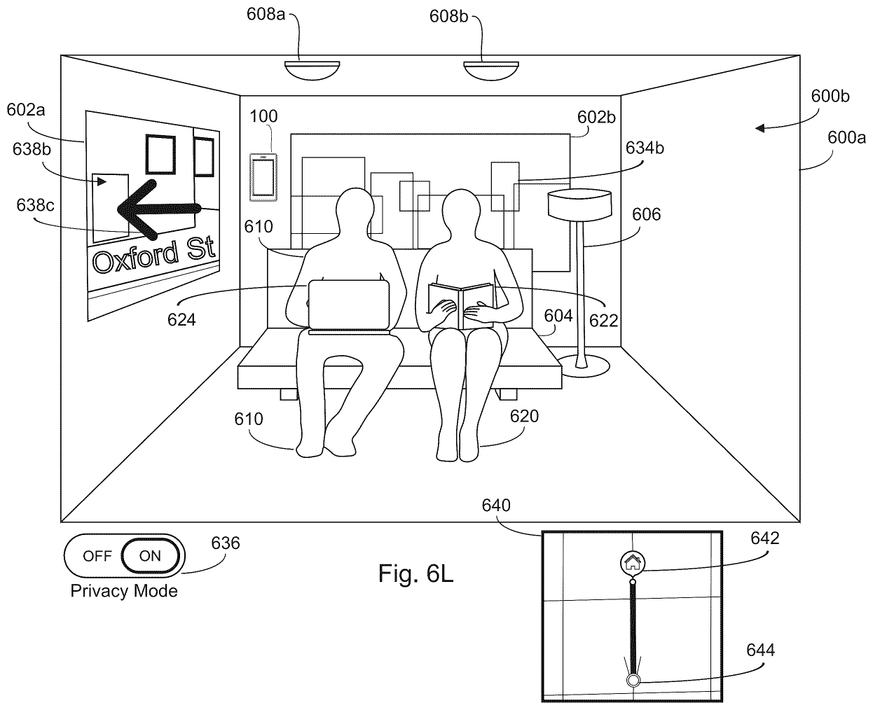

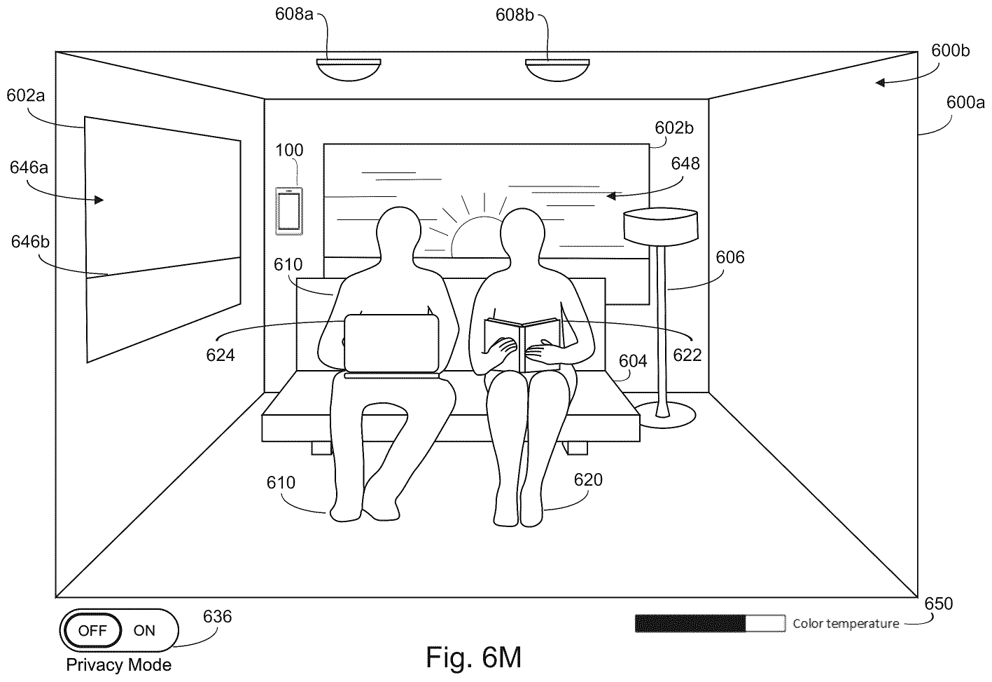

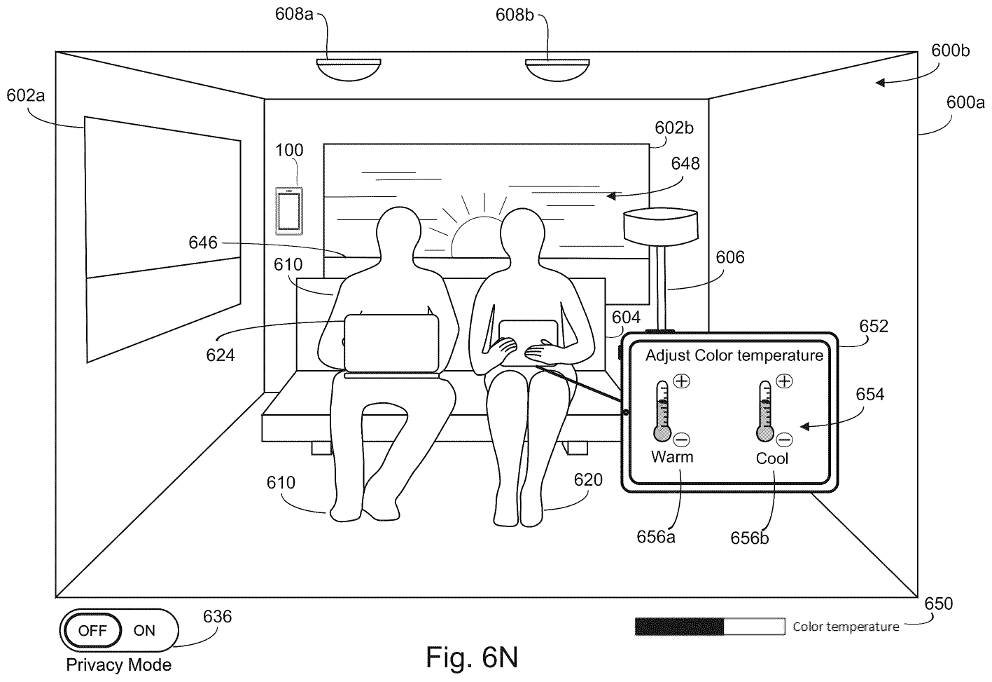

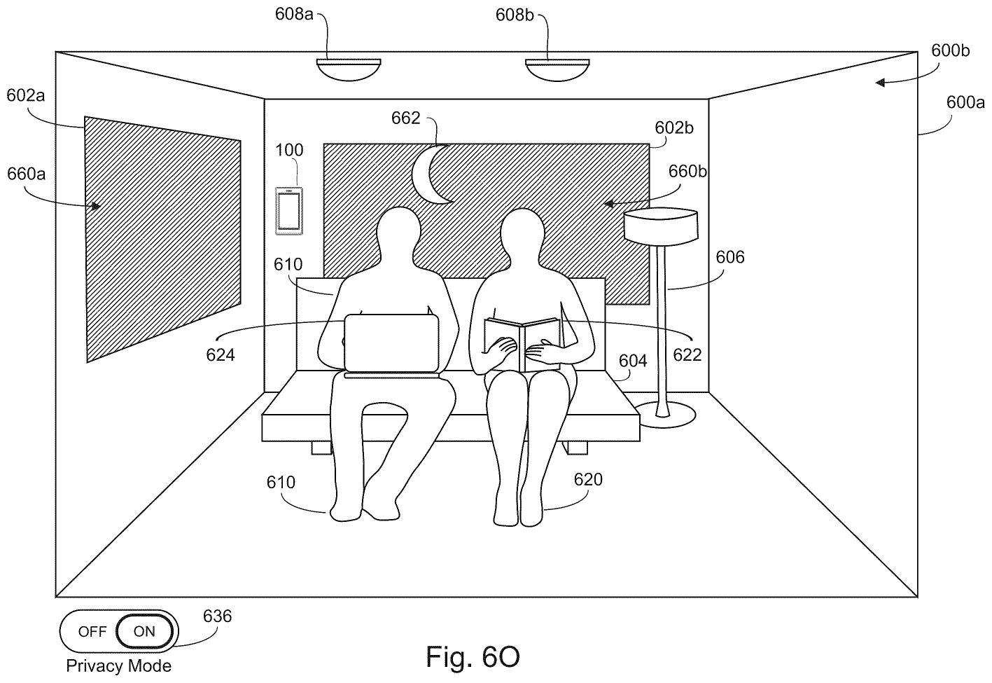

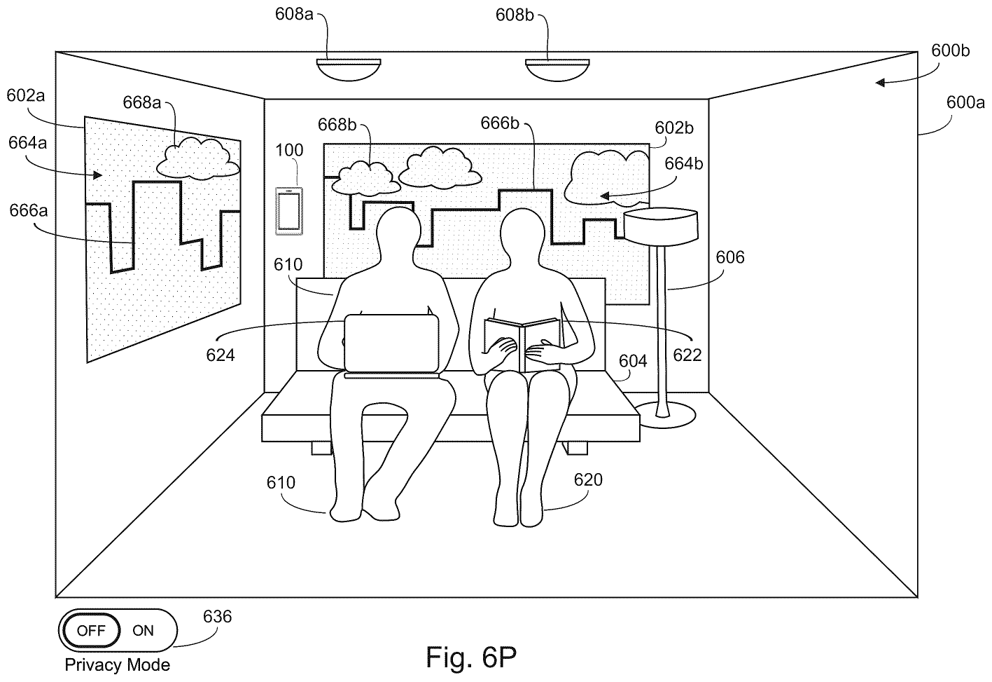

FIGS. 1A-6 provide a description of example computer systems for providing XR experiences to users (such as described below with respect to methods 800 and/or 1000). FIGS. 6A-6P illustrate adjusting the output of light in an interior of a platform and displaying a visual indication of one or more environmental factors of an environment external to the interior of the platform.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers or output devices 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

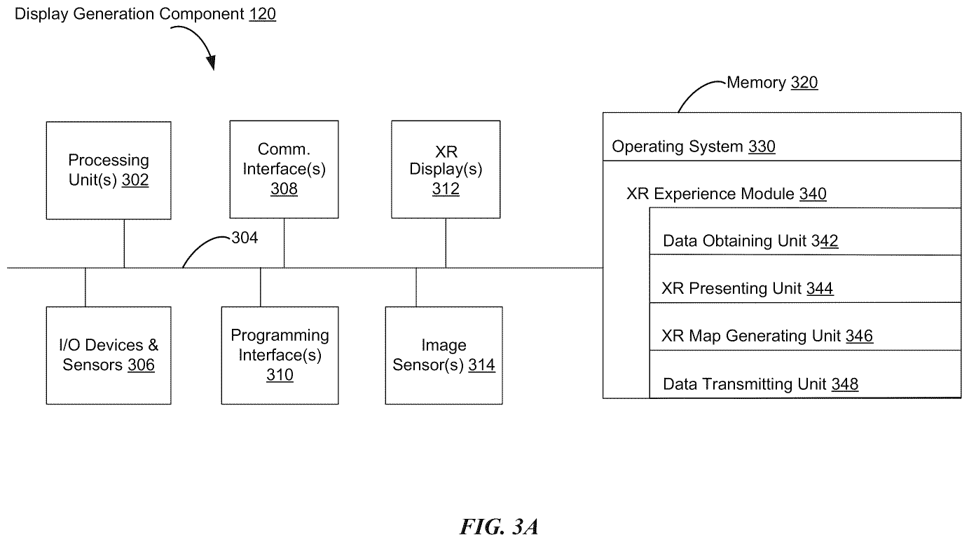

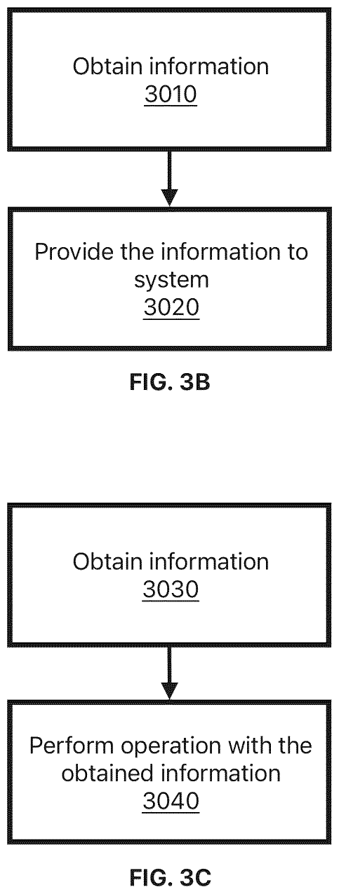

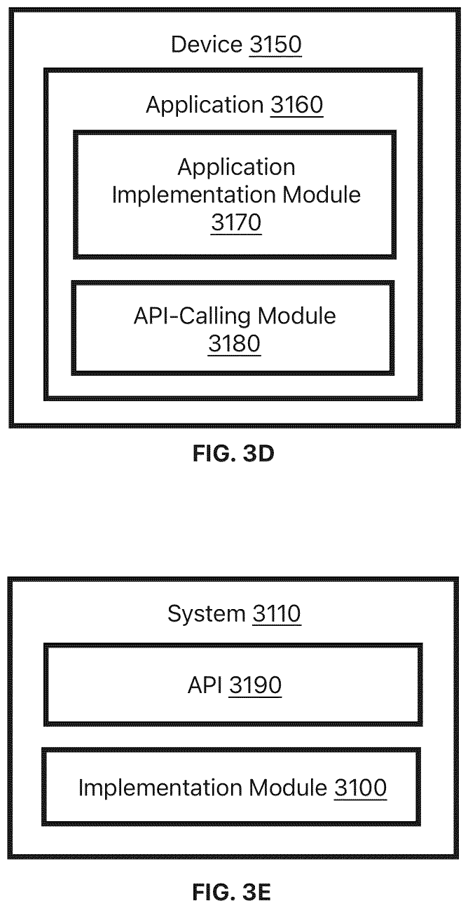

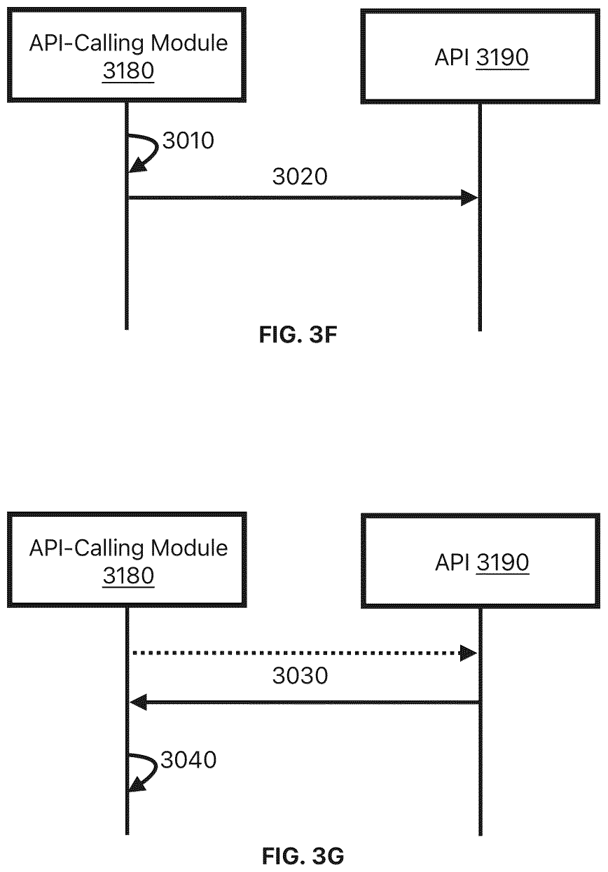

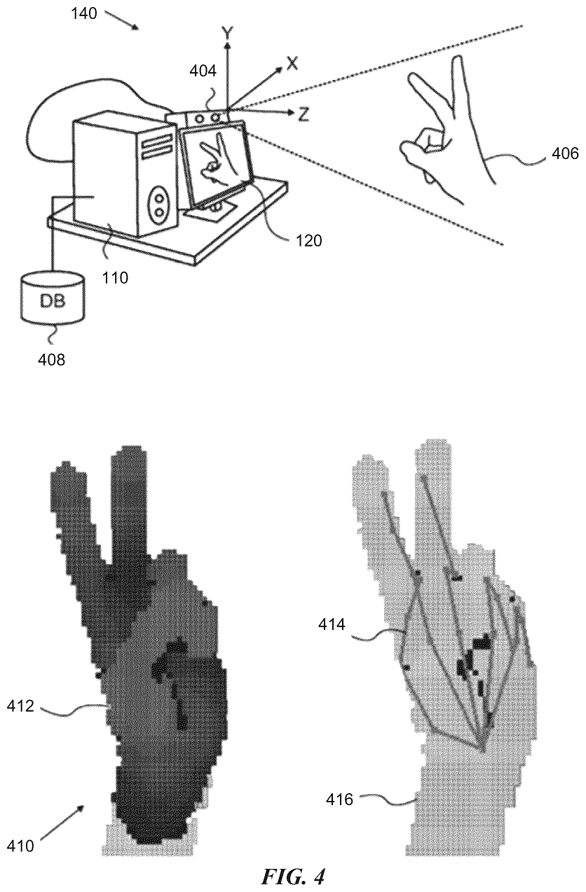

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be clastic or at least partially elastic.

Any of the features, components, and/or parts, including the arrangements and configurations thereof shown in FIGS. 1B and 1C can be included, cither alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, IC, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, cither alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

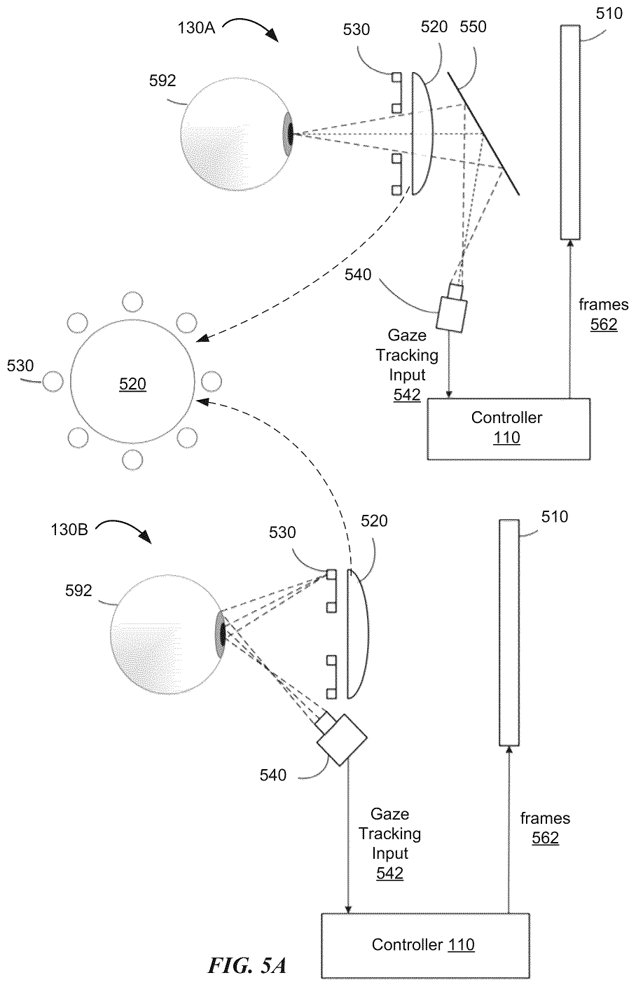

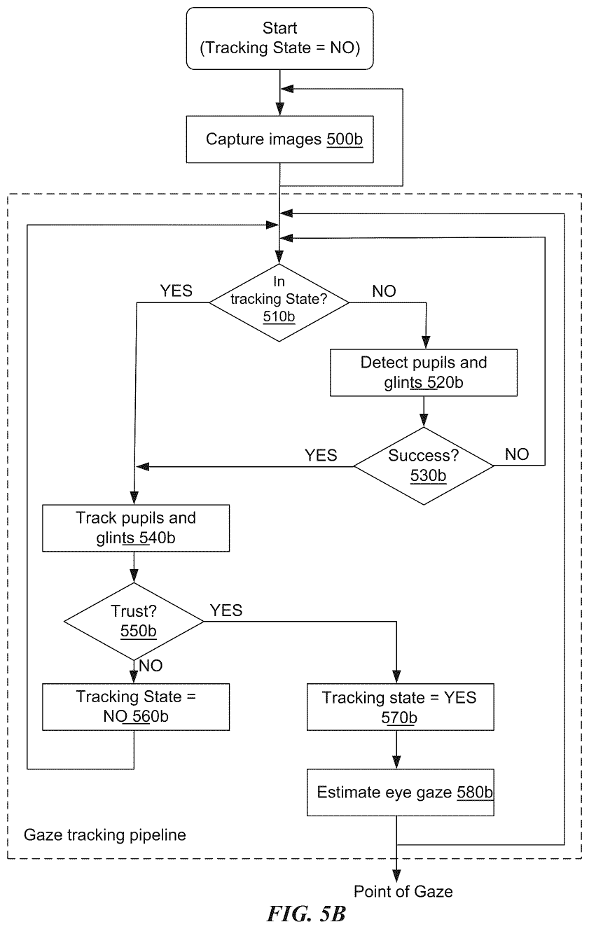

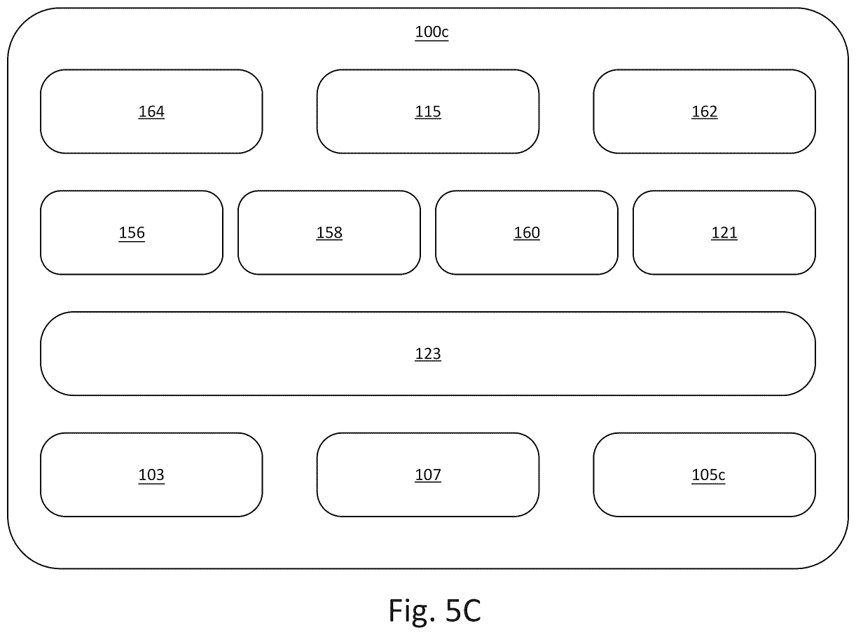

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5A.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

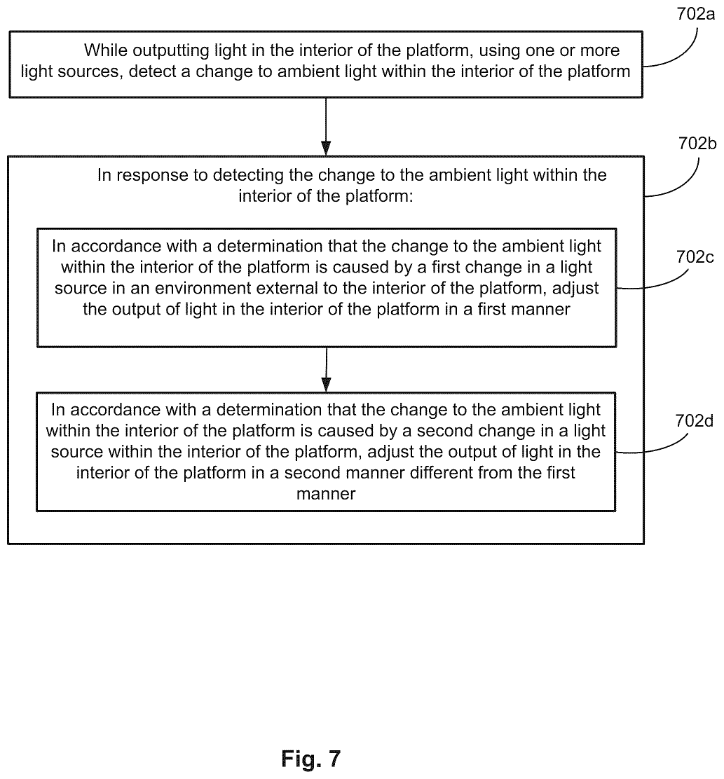

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5A illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5A, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5A, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5A), or alternatively may be pointed towards the user's eye(s) 592 to receive reflected IR or NIR light from the eye(s) 592 (e.g., as shown in the bottom portion of FIG. 5A).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5A. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5A may, for example, be used in computer-generated reality, virtual reality, and/or mixed reality applications to provide computer-generated reality, virtual reality, augmented reality, and/or augmented virtuality experiences to the user.

FIG. 5B illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 5B, the gaze tracking cameras may capture left and right images of the user's left and right eyes. The captured images are then input to a gaze tracking pipeline for processing beginning at 510b. As indicated by the arrow returning to element 500b, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 510b, for the current captured images, if the tracking state is YES, then the method proceeds to element 540b. At 510b, if the tracking state is NO, then as indicated at 520b the images are analyzed to detect the user's pupils and glints in the images. At 530b, if the pupils and glints are successfully detected, then the method proceeds to element 540b. Otherwise, the method returns to element 510b to process next images of the user's eyes.

At 540b, if proceeding from element 510b, the current frames are analyzed to track the pupils and glints based in part on prior information from the previous frames. At 540b, if proceeding from element 530b, the tracking state is initialized based on the detected pupils and glints in the current frames. Results of processing at element 540b are checked to verify that the results of tracking or detection can be trusted. For example, results may be checked to determine if the pupil and a sufficient number of glints to perform gaze estimation are successfully tracked or detected in the current frames. At 550b, if the results cannot be trusted, then the tracking state is set to NO at element 560b, and the method returns to element 510b to process next images of the user's eyes. At 550b, if the results are trusted, then the method proceeds to element 570b. At 570b, the tracking state is set to YES (if not already YES), and the pupil and glint information is passed to element 580b to estimate the user's point of gaze.

FIG. 5B is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment are used to provide a XR experience to the user, for example, a mixed reality environment in which one or more virtual objects are superimposed over representations of real world environment.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

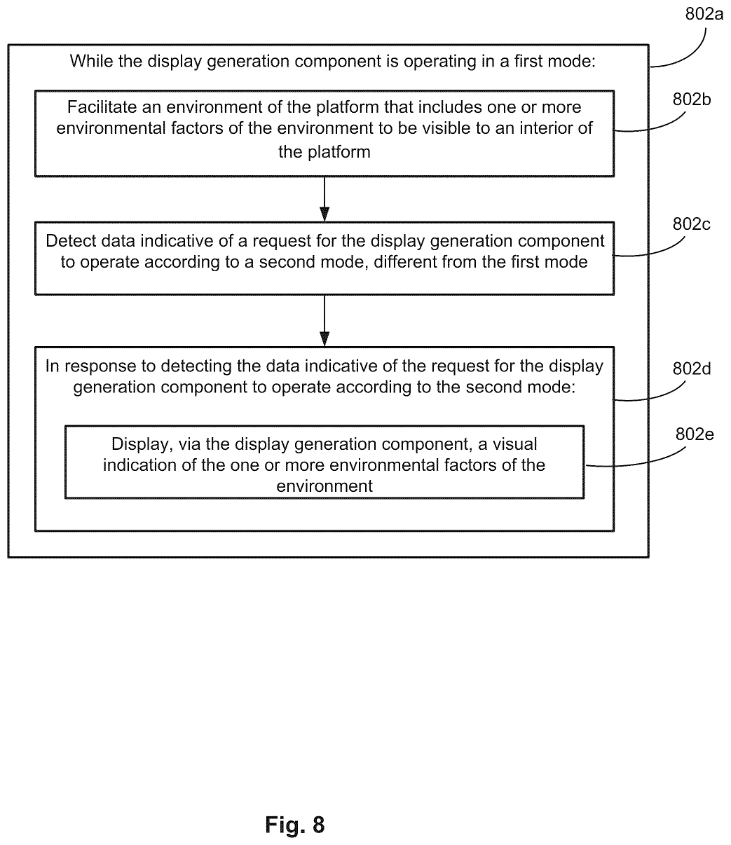

FIG. 5C provides illustrations of exemplary devices for performing techniques for controlling one or more objects within and/or integrated with a platform in response to a change in the environment external to the interior of the platform and/or a change in the interior of the platform. FIGS. 6A-6P illustrate examples of an electronic device controlling one or more objects within and/or integrated with a platform in response to a change in the environment external to the interior of the platform and/or a change in the interior of the platform in accordance with some embodiments. The user interfaces in FIGS. 6A-6G are used to illustrate the processes described below, including the processes in FIGS. 7-8.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 5C illustrates an example system 100c for implementing techniques described herein. System 100c can perform any of the methods described in FIGS. 7 and/or 8 (e.g., methods 700 and/800) and/or portions of these methods.

In FIG. 1, system 100c includes various components, such as processor(s) 103, RF circuitry(ies) 105c, memory(ies) 107, sensors 156 (e.g., image sensor(s), orientation sensor(s), location sensor(s), heart rate monitor(s), temperature sensor(s)), input component(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output component(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input component.

In some embodiments, system 100c is a mobile and/or movable device (e.g., a tablet, a smart phone, a laptop, head-mounted display (HMD) device, and or a smartwatch). In other embodiments, system 100c is a desktop computer, an embedded computer, and/or a server.

In some embodiments, processor(s) 103 includes one or more general processors, one or more graphics processors, and/or one or more digital signal processors. In some embodiments, memory(ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry(ies) 105c includes circuitry for communicating with electronic devices and/or networks (e.g., the Internet, intranets, and/or a wireless network, such as cellular networks and wireless local area networks (LANs)). In some embodiments, RF circuitry(ies) 105c includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100c includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform. For example, system 100c uses orientation sensors to track changes in the location and/or orientation (sometimes collectively referred to as position) of system 100c, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100c and/or sensors that are on an exterior of system 100c. In some embodiments, system 100c uses sensor(s) 156 (e.g., interior sensors) to detect a presence and/or state (e.g., location and/or orientation) of a passenger in the interior portion of system 100c. In some embodiments, system 100c uses sensor(s) 156 (e.g., external sensors) to detect a presence and/or state of an object external to system 100c. In some embodiments, system 100c uses sensor(s) 156 to receive user inputs, such as hand gestures and/or other air gesture. In some embodiments, system 100c uses sensor(s) 156 to detect the location and/or orientation of system 100c in the physical environment. In some embodiments, system 100c uses sensor(s) 156 to navigate system 100c along a planned route, around obstacles, and/or to a destination location. In some embodiments, sensor(s) 156 include one or more sensors for identifying and/or authenticating a user of system 100c, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100c. In some embodiments, system 100c uses CCD sensors, cameras, and depth sensors in combination to detect the physical environment around system 100c. In some embodiments, image sensor(s) includes a first image sensor and a second image sensor different form the first image sensor. In some embodiments, system 100c uses image sensor(s) to receive user inputs, such as hand gestures and/or other air gestures. In some embodiments, system 100c uses image sensor(s) to detect the location and/or orientation of system 100c in the physical environment.

In some embodiments, system 100c uses orientation sensor(s) for detecting orientation and/or movement of system 100c. For example, system 100c can use orientation sensor(s) to track changes in the location and/or orientation of system 100c, such as with respect to physical objects in the physical environment. In some embodiments, orientation sensor(s) includes one or more gyroscopes, one or more inertial measurement units, and/or one or more accelerometers.

In some embodiments, system 100c uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100c and/or outside of system 100c) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100c. In some embodiments, input device(s) 158 include one or more input devices (e.g., a touch-sensitive surface and/or keypad) on an exterior of system 100c.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100c. In some embodiments, environmental controls 162 includes fan(s), heater(s), air conditioner(s), and/or thermostat(s) for controlling the temperature and/or airflow within the interior portion of system 100c.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery(ies)), transmission(s), suspension system(s), speed control system(s), and/or steering system(s). In some embodiments, one or more elements of mobility component(s) are configured to be controlled autonomously or manually (e.g., via system 100c and/or input device(s) 158).

In some embodiments, system 100c performs monetary transactions with or without another computer system. For example, system 100c, or another computer system associated with and/or in communication with system 100c (e.g., via a user account described below), is associated with a payment account of a user, such as a credit card account or a checking account. To complete a transaction, system 100c can transmit a key to an entity from which goods and/or services are being purchased that enables the entity to charge the payment account for the transaction. As another example, system 100c stores encrypted payment account information and transmits this information to entities from which goods and/or services are being purchased to complete transactions.

System 100c optionally conducts other transactions with other systems, computers, and/or devices. For example, system 100c conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105c.

In some embodiments, system 100c is capable of communicating with other computer systems and/or electronic devices. For example, system 100c can use RF circuitry(ies) 105c to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100c. In some embodiments, system 100c captures video and/or audio content using sensor(s) 156 to be transmitted to the other system(s) in the videoconferencing communication sessions using RF circuitry(ies) 105c. In some embodiments, system 100c receives, using the RF circuitry(ies) 105c, video and/or audio from the other system(s) in the videoconferencing communication sessions, and presents the video and/or audio using output component(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100c generates tactile (e.g., haptic) outputs using output component(s) 160. In some embodiments, output component(s) 160 generates the tactile outputs by displacing a moveable mass relative to a neutral position. In some embodiments, tactile outputs are periodic in nature, optionally including frequency(ies) and/or amplitude(s) of movement in two or three dimensions. In some embodiments, system 100c generates a variety of different tactile outputs differing in frequency(ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency(ies) corresponds to faster movement(s) by the moveable mass whereas lower frequency(ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100c. For example, system 100c can includes tactile output device(s) that move a moveable mass to generate tactile output and can include other moving part(s), such as motor(s), wheel(s), axel(s), control arm(s), and/or brakes that control movement of system 100c. Although movement and/or cessation of movement of system 100c generates vibrations and/or other physical sensations in some situations, these vibrations and/or other physical sensations are distinct from tactile outputs. In some embodiments, system 100c generates tactile output independent from movement of system 100c For example, system 100c can generate a tactile output without accelerating, decelerating, and/or moving system 100c to a new position.

In some embodiments, system 100c detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input component(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100c uses one or more microphones of input component(s) 158 to detect the user speaking one or more words. In some embodiments, system 100c parses and/or communicates information to one or more other systems to determine contents of the speech of the user, including identifying words and/or obtaining a semantic understanding of the words. For example, system processor(s) 103 can be configured to perform natural language processing to detect one or more words and/or determine a likely meaning of the one or more words in the sequence spoken by the user. Additionally or alternatively, in some embodiments, the system 100c determines the meaning of the one or more words in the sequence spoken based upon a context of the user determined by the system 100c.

In some embodiments, system 100c outputs spatial audio via output component(s) 160. In some embodiments, spatial audio is output in a particular position. For example, system 100c can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100c presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100c presents feedback including generating audio as if emanating from the second position.

In some embodiments, system 100c communicates with one or more accessory devices. In some embodiments, one or more accessory devices is integrated with system 100c. In some embodiments, one or more accessory devices is external to system 100c. In some embodiments, system 100c communicates with accessory device(s) using RF circuitry(ies) 105c and/or using a wired connection. In some embodiments, system 100c controls operation of accessory device(s), such as door(s), window(s), lock(s), speaker(s), light(s), and/or camera(s). For example, system 100c can control operation of a motorized door of system 100c. As another example, system 100c can control operation of a motorized window included in system 100c. In some embodiments, accessory device(s), such as remote control(s) and/or other computer systems (e.g., smartphones, media players, tablets, computers, and/or wearable devices) functioning as input devices control operations of system 100c. For example, a wearable device (e.g., a smart watch) functions as a key to initiate operation of an actuation system of system 100c. In some embodiments, system 100c acts as an input device to control operations of another system, device, and/or computer, such as the platform 100c functioning as a key to initiate operation of an actuation system of a platform associated with another system, device, and/or computer.

In some embodiments, digital assistant(s) help a user perform various functions using system 100c. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100c and a server-side portion executed on a server in communication with system 100c. The client-side portion can communicate with the server through a network connection using RF circuitry(ies) 105c. The client-side portion can provide client-side functionalities, input and/or output processing and/or communication with the server, for example. In some embodiments, the server-side portion provides server-side functionalities for any number client-side portions of multiple systems.

In some embodiments, system 100c is associated with one or more user accounts. In some embodiments, system 100c saves and/or encrypts user data, including files, settings, and/or preferences in association with particular user accounts. In some embodiments, user accounts are password-protected and system 100c requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

Users interact with electronic devices in many different manners. In some embodiments, an electronic device adjusts the output of light from one or more light sources within an interior of a platform in response to a change in ambient light within the interior of the platform. In some embodiments, adjusting the output of light enables users within the platform to view information and operate devices without the need for subsequent inputs from users to manipulate the one or more lights sources, thus reducing power usage and improving battery life of the electronic device and conserving power of the one or more light sources by automatically adjusting light more quickly and efficiently.

In some embodiments, an electronic device displays a visual indication of one or more environmental factors of an environment external to the interior of the platform. In some embodiments, displaying the visual indication enables users within the platform to view information about the environment while also providing users with privacy, thus preserving user privacy while reducing potential disorientation of the users within the platform being unable to determine their spatial position relative to the environment.

FIGS. 6A-6P illustrate examples of the electronic device controlling one or more objects within and/or integrated with the platform in response to a change in the environment external to the interior of the platform and/or a change in the interior of the platform. For example, the electronic device adjusts the output of light from the one or more light sources within the interior of the platform in response to the change in ambient light within the interior of the platform. In some embodiments, the electronic device adjusts the output of light in a manner that is based on a kind or type of change to the ambient light within the interior of the platform, as well as other information (e.g., user activity, operating mode of the platform, and/or location).

In other example embodiments, the electronic device displays or causes to display the visual indication of one or more environmental factors of the environment external to the interior of the platform. In some embodiments, the one or more environmental factors include pedestrians, drivers and passengers in vehicles, bicyclists, aerial vehicles, and/or other environmental factors described below. In some embodiments, the visual indication of the one or more environmental factors of the environment of the platform includes an appearance that is based on the one or more environmental factors such that the user is able to recognize objects in the environment while also providing the user with privacy.

FIG. 6A illustrates an interior 600b of a platform 600a with display components 602a and 602b. In some embodiments, the platform 600a is a vehicle (e.g., car, bus, truck, airplane, train, boat, or other vehicle configured for transportation of a user), a house, store, or other building. In some embodiments, display components 602a and 602b are displays integrated with (optionally one or more exterior windows or windshields of) the vehicle or other platform for projecting a user interface or causing a user interface to be visible to one or more users (e.g., user 610) within the interior 600b of the platform 600a as will be described with reference to FIGS. 6I-6P. In some embodiments, the platform 600a is in communication with a system 100c (e.g., operating environment 100 in FIG. 1A, and/or HMD 1-100 in FIGS. 1B and 1C) configured to control one or more light sources associated with the platform to output light as will be described herein. In some embodiments, the system 100c is a mobile device as shown in FIG. 6A. In some embodiments, the system 100c is a device other than a mobile device as described with reference to method 700.

As shown in FIG. 6A, the interior 600b of the platform 600a includes light sources 608a, 608b, and 606. In some embodiments, and as will be described herein and with reference to method(s) 700 and 800, the system 100c is configured to control one or more light sources to output light. For example, the system 100c detects a change to ambient light within an interior of the platform, and in response, the system 100c initiates and/or controls the output of light of the one or more light sources. The level of ambient light is illustrated by ambient light indicator 612 having a first magnitude of ambient light. As described herein and with reference to method(s) 700 and 800, ambient light optionally refers to light present within the interior 600b space of the platform 600a, such as provided by interior ceiling lights (e.g., light sources 608a and 608b), floor lights, dashboard/instrument cluster lights and/or other lights (e.g., light source 606 and/or light entering the platform 600a from the outside of the platform 600a through display components 602a and/or 602b) existing in the interior 600b of the platform 600a produced by one or more light sources discussed herein and with reference to method(s) 700 and 800.

FIG. 6A further includes light source indicators: 614a corresponding to light source 608a; 614b corresponding to light source 608b; and 616 corresponding to light source 606. The light source indicators 614a, 614b, and 616 include a respective magnitude of light that is output in response to a change to the ambient light as will be described in FIG. 6B. Although the Figs. described herein are directed to a magnitude of light, such lighting adjustments optionally apply to intensity, luminance, and/or color temperature of lighting as will be described in more detail with reference to method(s) 700 and/or 800. FIG. 6A further illustrates a user 610, and one or more objects in the interior of the platform, such as portions of right, left and back walls, a floor, and a couch 604 in the interior of the platform.

In some embodiments, the system 100c outputs the light in the interior of the platform in accordance with the ambient light as described herein. For example, the system 100c adjusts the output of light from the one or more light sources within the interior of the platform in response to the change in ambient light within the interior of the platform. For example, the ambient light indicator 612 in FIG. 6B corresponding to the ambient light within the interior 600b of the platform 600a indicates a second magnitude of light that is less than the ambient light indicator 612 in FIG. 6A corresponding to the first magnitude of light. In some embodiments, the system 100c detects a change from the magnitude of ambient light shown in FIG. 6A to the magnitude of ambient light shown in FIG. 6B (e.g., decrease in magnitude of ambient light). In some embodiments, in response to detecting the change from the magnitude of ambient light shown in FIG. 6A to the magnitude of ambient light shown in FIG. 6B, the system 100c outputs light from the one or more lights sources within the interior of the platform from that shown in FIG. 6A to that shown in FIG. 6B. For example, in FIG. 6B, in response to the change in the ambient light, the system 100c adjusts the output of light from light sources 608a and 606 in a first manner (e.g., increasing the respective magnitude of light as shown by indicators 614a and 616, respectively, compared to the light indicators 614a and 616 in FIG. 6A).

In FIG. 6A, the ambient light indicator 612 corresponding to the ambient light within the interior 600b of the platform 600a indicates a magnitude of light greater than the magnitude of light of the ambient light indicator 612 in FIG. 6B. In some embodiments, the magnitude of ambient light is caused by a light source in the environment external to the interior 600b of the platform 600a, such as the moon 618 in FIG. 6B or the sun 628 in FIG. 6F.

In some embodiments, the system 100c operates particular light sources independently of one another. For example, and as show in FIG. 6B, the system 100c operates light source 608a and not light source 608b as illustrated by indicators 614a and 614b, respectively, because the system 100c determines that user 610 is closer to light source 608a (e.g., within a predetermined distance as described in method 700) than to light source 608b. In some embodiments, although light source 606 is farther than the predetermined distance from the user 610, the system 100c operates light source 606 as illustrated by indicator 616 in order to meet or satisfy a predetermined target amount of illumination as described in method 700. In some embodiments, the system 100c operates light source 606 instead of light source 608b because the system 100c determines that operating light source 606 requires less energy to meet the predetermined target amount of illumination in the space than the energy required for operating light source 608b to meet the predetermined target amount of illumination. In some embodiments, the system 100c elects to operate the output of light from a particular light source based on a variety of factors and/or conditions described with reference to method(s) 700 and 800.

In some embodiments, the system 100c outputs light from the one or more light sources within the interior of the platform in a manner corresponding to a determination that a user within the interior of the platform is interacting with an object. As described with reference to method(s) 700 and 800, the platform is optionally a space or room in a vehicle, house, store, building, or other enclosed space. For example, FIG. 6C shows user 610 and user 620 within the interior of the platform while user 620 is interacting with an object (e.g., reading a book 622). In some embodiments, in response to a determination that user 620 is reading a book 622, the system 100c outputs light from light source 608b located above user 620 at a level corresponding to the user 620 reading. For example, in FIG. 6C with the light source indicator 614b corresponding to the output of light from light source 608b with a magnitude of light that is greater than the magnitude of light associated with the light source indicator 614a corresponding to output of light from light source 608a.

In some embodiments, the system 100c activates one or more light sources and/or initiates the output of light from one or more light sources in response to a determination that the one or more light sources are within a predetermined distance from a user as described in method 700. In some embodiments, the system 100c controls the output of light from the one or more light sources within the interior of the platform in accordance with a location of the user as described herein. For example, in FIG. 6B, the light source indicator 614b corresponding to the output of light from light source 608b is not activated, thereby illustrated as having zero magnitude (e.g. light source 608b does not output light). In some embodiments, the system 100c activates light source 608b to output light as shown in FIG. 6C where light source indicator 614b includes a magnitude of light greater than zero. In some embodiments, the system 100c detects the presence of user 620 within the interior of the platform as shown in FIG. 6C. In some embodiments, in response to a change from the absence of user 620 shown in FIG. 6B to the presence of user 620 shown in FIG. 6C, the system 100c activates light source 608b located within the predetermined distance from the user 620. For example, the light source indicator 614b in FIG. 6C corresponding to the output of light from light source 608b includes a magnitude of light that is greater than the magnitude of light associated with the light source indicator 614b in FIG. 6B having zero magnitude. In some embodiments, the system 100c activates and/or adjusts the output of light from light source 608b irrespective of whether user 620 is interacting with an object (e.g., reading a book 622). In some embodiments, the system 100c activates and/or adjusts the output of light from light source 608b in a manner different from the manner in which the system 100c activates and/or adjusts the output of light from light source 608b when the electronic device detects that user 620 is not interacting with the object. For example, in response to the system 100c detecting the presence of user 620 within the interior of the platform, and in accordance with a determination that user 620 is not interacting with the object (e.g., book 622), the electronic device activates and/or adjusts light source 608b that is located with the predetermined distance from user 620 in a manner similar to or corresponding to light source indicator 614a in FIG. 6C. In another example, in response to the system 100c detecting the presence of user 620 within the interior of the platform, and in accordance with a determination that user 620 is interacting with the object, the electronic device activates and/or adjusts light source 608b that is located with the predetermined distance from user 620 in a manner different from the manner in which the system 100c activates and/or adjusts the lights source 608b when the user is not determined to be interacting with the object (e.g., light source indicator 614b includes a magnitude of light that is greater than the magnitude of light associated with the light source indicator 614a in FIG. 6C).

In some embodiments, the system 100c controls the output of light from the one or more light sources within the interior of the platform in a manner corresponding to a determination of a time of day (e.g., early morning, morning, mid-day, afternoon, evening, or nighttime). For example, in FIG. 6D, the ambient light indicator 612 that corresponds to the ambient light within the interior 600b of the platform 600a indicates a magnitude of light that is greater than the ambient light indicator 612 in FIG. 6C. In some embodiments, the system 100c detects a change from the magnitude of ambient light shown in FIG. 6C to the magnitude of ambient light shown in FIG. 6D (e.g., increase in magnitude of ambient light). In some embodiments, in response to detecting the change from the magnitude of ambient light shown in FIG. 6C to the magnitude of ambient light shown in FIG. 6D, the system 100c outputs light from the one or more lights sources within the interior of the platform from that shown in FIG. 6C to that shown in FIG. 6D. For example, the change from the magnitude of ambient light shown in FIG. 6C to the magnitude of ambient light shown in FIG. 6D is optionally caused by an environmental change, such as from nighttime to daytime as indicated by the absence of the moon 618 indicative of nighttime that was in the environment external to the interior of the platform visible via display component 602b in FIG. 6C.

In some embodiments, system 100c is configured to detect the output of light from one or more second electronic devices, different from the system 100c. For example, in FIG. 6E, user 610 is interacting with a second electronic device 624 (e.g., a laptop). The electronic device 624 includes a display screen that projects light with a first magnitude as illustrated by light source indicator 626 in FIG. 6E. The ambient light indicator 612 in FIG. 6E includes a magnitude of light greater than the magnitude of light of the ambient light indicator 612 in FIG. 6D. In some embodiments, the magnitude of light of ambient light indicator 612 in FIG. 6E is caused by the electronic device 624.

In some embodiments, to minimize or prevent glare on the display screen of electronic device 624, the system 100c adjusts the output of light from light source 608a as indicated with the magnitude of light of light source indicator 614a in FIG. 6E that is now less than the respective magnitude of light corresponding to light source 608a as indicated by the light source indicator 614a in FIG. 6D in which the user 610 was not using electronic device 624. In some embodiments, the system 100c sets the output of light from electronic device 624 in accordance with lighting conditions in the platform. For example, in FIG. 6F, the system 100c detects greater ambient light caused by one or more environmental factors (e.g., the sun 628) from the environment external to the interior 600b of the platform 600a than the magnitude of ambient light in FIG. 6E. This increased amount of ambient light is illustrated by the magnitude of ambient light of the ambient light indicator 612 in FIG. 6F being greater than a respective magnitude of ambient light associated with the ambient light indicator 612 in FIG. 6E. In some embodiments, in accordance with the amount of ambient light caused by direct sunlight from the sun 628 in FIG. 6F, the system 100c sets the output of light from the display of the electronic device 624 at a magnitude indicated by indicator 626 that is greater in FIG. 6F than the magnitude indicated by indicator 626 in FIG. 6E. Using an increased brightness for the display of electronic device 624 in FIG. 6F may minimize or reduce glare on the display screen which may be caused by direct sunlight from the sun 628.

In some embodiments, in accordance with the amount of ambient light, including direct sunlight from the sun 628, in FIG. 6F, the system 100c operates light sources 608a, 608b, and 606 as shown by light source indicators 614a, 614b, and 616, respectively. For example, the respective magnitude of light associated with light source indicators 614a, 614b, and 616 is now lower in FIG. 6F than the amounts in FIG. 6E when there was less ambient light. In some embodiments, to further reduce glare on the display screen of electronic device 624, the system 100c operates light source 608a in a manner different from operation of light source 608b because light source 608s is closer (e.g., within a predetermined distance as described with reference to method 700) to the user 610 interacting with electronic device 624. This difference is illustrated by the magnitude of light associated with light source indicator 614a corresponding to light source 608a that is less than a respective magnitude of light associated with light source indicator 614b corresponding to light source 608b in FIG. 6F. In some embodiments, and as described in more detail with reference to methods 700 and 800, the manner in which the system 100c controls the output of light from one or more lights sources (e.g., 608a, 606b, 606, and/or 624) is based on one or more conditions or a combination of conditions.

In some embodiments, when the system 100c determines that the amount of lighting (e.g., direct sunlight caused by sun 628) exceeds the predetermined target amount of illumination and/or is within a range of lighting values as described in method(s) 700 and/or 800, the system 100c applies an amount of color and/or shade (e.g., color/shade 630a and 630b) to the display components 602a and 602b as shown in FIG. 6G. Accordingly, in some embodiments, the display components 602a and 602b serve as electrically-adjustable shades for the platform 600a. In some embodiments, the system 100c applies adjustable amounts of color and/or shade to reflect, transmit, and/or absorb the direct sunlight from the sun 628 in FIG. 6F that is projected into the interior 600b of the platform 600a as described in more detail with reference to method(s) 700 and/or 800.

FIG. 6G further illustrates that because of the amount of color/shade 630a and 630b applied, by the system 100c, to display components 602a and 602b, respectively, the magnitude of light associated with the ambient light indicator 612 is now decreased to an amount less than the amount associated with the ambient light indicator 612 prior to applying the color/shade 630a and 630b as shown in FIG. 6F. In response to said change in ambient light, the system 100c adjusts the output of light from light sources 608a, 608b, 606, and 624. For example, light source indicators 614a, 614b, 616, and 626 having respective magnitudes of light that are now greater than the respective magnitudes of light associated with light source indicators 614a, 614b, 616, and 626 in FIG. 6F (e.g., prior to the change in ambient light caused by the color/shade 630a and 630b applied, by the system 100c, to display components 602a and 602b). In some embodiments, and as shown in FIG. 6G, the manner in which the output of light from light source 608a is different (e.g., less amount of light) than the output of light from light source 608b because of one or more factors including a determination that user 610 is interacting with laptop 624. Accordingly, to minimize glare on the display of electronic device 624, the system 100c optionally adjusts the output of light from light source 608a differently than the light source 608b. One or more other factors and/or optionally in combination with the factors described herein are considered by the system 100c and are described in more detail with reference to method(s) 700 and/or 800.

In some embodiments, the system 100c detects and/or captures information about and/or objects in the environmental external to the interior 600b of the platform 600a via display components 602a and/or 602b. As described with reference to method 800 and FIGS. 6H-6P, the system 100c displays a visual indication of the one or more objects (e.g., one or more environmental factors described in method 800) via the display components 602a and/or 602b. For example, in FIG. 6H, while the display components 602a and 602b are operating in a normal (non-private) mode as illustrated by privacy mode indication 636 having the value “off”, the system 100c foregoes adjusting a translucency and/or tint of the display components 602a and 602b to obscure the interior 600b of the platform 600a from the outside of the platform 600a, or vice versa. Accordingly, in FIG. 6H, exterior objects, such as pedestrians 632a and buildings 634a are viewable to users 610 and 620 via display components 602a and 602b.

In some embodiments, the system 100c receives a request for display component 602a and/or 602b to operate according to a private mode, such as illustrated in FIG. 6I by privacy mode indication 636 having the value “on”. In some embodiments, privacy mode is an operating mode in which observers who are exterior to the platform are not permitted to readily view the interior of the platform via the display component, or vice versa. In response to receiving the request for display component 602a and/or 602b to operate according to a private mode, the system 100c displays, via display component 602a and/or 602b, a visual indication 632b. For example, in FIG. 6I, the system 100c, displays, via display component 602a, visual indication 632b of pedestrians 632a shown in FIG. 6H. FIG. 6I further illustrates that the system 100c displays, via display component 602b, visual indication 634b of buildings 634a shown in FIG. 6H. In some embodiments, the visual indication 632b is displayed having a shape similar to their corresponding objects as shown by visual indication 632b. In some embodiments, the visual indication is displayed having an abstract visual appearance as shown by visual indication 634b. The visual appearance of the visual indication is described in more detail with reference to method 800.

In some embodiments, the system 100c moves the visual indication 632b of the exterior objects in accordance with the detected movement of the exterior objects. For example, from FIG. 6I to FIG. 6J, the system 100c detects movement, via one or more sensors described in method 800, of the exterior objects (e.g., pedestrians 632a) from a left side to a right side (e.g., relative to display component 602a) of the platform 600a. In response to the detected movement of the pedestrians 632a from the left side to the right side of the platform 600a, the system 100c, displays, via display component 602a, the visual indication 632b as moving from a left side to a right side of the display component 602a (e.g., corresponding to a magnitude, speed, acceleration and/or direction of the movement of the pedestrians 632a). In some embodiments, the system 100c displays, via the display component 602a, visual indications 632b and 634b at respective locations corresponding to the exterior objects (e.g., pedestrians 632a and buildings 634a) even when the system 100c detects that the exterior objects are not moving.

In some embodiments, the system 100c displays a visual indication indicative of location information of the platform 600a, as shown in FIG. 6L. For example, from FIG. 6K to FIG. 6L, the display components 602a and 602b change from operating according to a normal (non-private) mode as illustrated by privacy mode indication 636 having the value “off” in FIG. 6K to operating according to a private mode, such as illustrated in FIG. 6L by privacy mode indication 636 having the value “on”. In FIG. 6K, a street level view 638a of the environment external to the interior 600b of the platform 600a is visible via display component 602a. FIG. 6K also illustrates physical buildings 634a visible via display component 602b. In response to the display components 602a and 602b changing from operating according to the normal mode to the private mode as illustrated in FIG. 6L, the system 100c displays visual indication 638b representing the street level view 638a of FIG. 6K. In FIG. 6L, visual indication 638b resembles the street level view albeit without a level of detail associated with the street level view 638a presented via the display component 602a while operating in the normal mode shown in FIG. 6K. In some embodiments, the system 100c displays a visual indication 638c associated with location information being used to perform a function by the system 100c. For example, in FIG. 6L, the visual indication 638c includes a street name in which the platform 600a is currently navigating. Additionally and/or alternatively, the system 100c displays, via the display components 602a and/or 602b, visual indication 640 representing a map including a visual indication of a route, a visual indication of the destination 642, and a visual indication of a current location and orientation of the platform 644.

In some embodiments, the system 100c controls the output of the light in the interior of the platform to enhance the environment external to the interior 600b of the platform 600a. For example, in FIG. 6N, the environment external to the interior 600b of the platform 600a includes a sunset 648 presented via display component 602b. In some embodiments, in response to detecting the sunset 648, the system 100c controls the output of the light in the interior 600b of the platform 600a to visually accentuate the sunset 648 such that it appears to users 610 and 620 that the colors of the sunset 648 are within the interior of the platform in manner that is emphasized more than would be the case without operating the output of the light in the interior 600b of the platform 600a in accordance with the sunset. For example, in FIG. 6N by color temperature 650 having a color value similar to or corresponding to the colors of the sunset 648. In FIG. 6N, the system 100c displays, via display 652 of a second electronic device, a user interface element 654 including controls 656a and 656b interactable to cause the system 100c to adjust the color temperature of the interior 600b of the platform 600a. In some embodiments, the system 100c displays, via display components 602a and/or 602b, contextual information such as a representation of a horizon line 646 to indicate the position and/or location of the visual indication (e.g., sunset 648) relative to the representation of the horizon line 646. In some embodiments, the system 100c controls the output of light in the interior 600b of the platform 600a to visually reduce one or more environmental factors such as smog and/or wildfire smoke. For example, the system 100c applies a color correction to light output in the interior of the platform in response to the colors of the smog and/or wildfire smoke such that the colors of the smog and/or wildfire smoke are minimized to a degree than would be the case without controlling the output of the light in the interior 600b of the platform 600a.

In some embodiments, the system 100c displays the visual indication of the one or more environmental factors of the environment including a simulation of the moon 662 as shown in FIG. 6O. For example, while display components 602a and 602b are operating in the private mode as indicated by privacy mode indicator 636 having the value “on” such that users 610 and 620 located within the platform 600a are not able to readily view the environment external to the platform via the display components 602a and 602b, the system 100c detects the physical moon and displays the simulation of the moon 662 overlaid on a presentation of the physical environment 660b external to the interior 600b of the platform 600a. For example, the simulation of the moon 662 is optionally overlaid on the presentation of the sky of the physical environment. In some embodiments, the system 100c displays the simulation of the moon 662 including one or more visual characteristics corresponding to one or more visual characteristics of the moon being simulated, such as a position, phase, color, hue, tone, brightness, and/or texture of the moon being simulated as described in more detail with reference to method 800.

In some embodiments, when physical objects in the environment are partially visible or fully not visible in the environment, the system 100c displays a representation of the physical object in the display component corresponding to the respective location of the physical object in the environment. For example, in FIG. 6P, display components 602a and 602b are operating in normal mode as indicated by privacy indicator 636 having a value “off” and the physical environments 664a and 664b are visible to users 610 and 620. In FIG. 6P, the physical environments 664a and 664b include fog causing physical objects in the environment such as clouds and buildings to be partially visible or fully not visible. In response to the system 100c determining that physical objects included in the environment are not visible to the interior of the platform, the system 100c displays, via the display components 602a and 602b, representations of the physical objects (e.g., representations 668a, 666a, 668b, and 666b). Representations 668a, 666a, 668b, and 666b correspond to the clouds and buildings in the physical environment that would otherwise be visible in the environment if not for the foggy weather environments 664a and 664b.

FIG. 7 is a flow diagram illustrating a method in which an electronic device controls the output of light from one or more light sources within the interior of the platform in response to a change in ambient light within the interior of the platform. The method 700 is optionally performed at first and/or electronic devices such as system 100c as described above with reference to FIG. 1. Some operations in method 700 are, optionally combined and/or order of some operations is, optionally, changed.

In some embodiments, method 700 is performed at an electronic device (e.g., 100c) in communication with a platform, such as platform 600a in FIG. 6A. In some embodiments, the electronic device is a mobile device (e.g., a tablet, a smartphone, and/or a media player), a computer (e.g., a desktop computer and/or a laptop computer), an in-vehicle computer (e.g. vehicle on-board computer, vehicle information and entertainment system or infotainment system), and/or a wearable device (e.g. watch and/or a head-mounted device). In some embodiments, the platform is a vehicle (e.g., car, bus, truck, airplane, train, boat, or other vehicle configured for transportation of a user), a house, store, or other building. In some embodiments, the electronic device is in communication with the platform using wired or wireless communication. In some embodiments, the electronic device is located in the platform. In some embodiments, and as will be described herein, the electronic device is configured to control one or more light sources to output light. In some embodiments, and as will be described herein with respect to method 700, the electronic device detects a change to ambient light within an interior of the platform (e.g., confined space, such as the interior of a vehicle or room of a house), and in response the electronic device is configured to initiate the output of light or control the output of light via the one or more light sources. In some embodiments, method 700 is performed at or by a vehicle (e.g., at a lighting system, a multi-display system, and/or an infotainment system of an automobile having or in communication with one or more display components and/or input devices).

In some embodiments, while outputting light in the interior of the platform, using one or more light sources (e.g., interior ceiling lights, floor lights, dashboard/instrument cluster lights and/or other lights existing in the interior of the platform produced by the one or more light sources discussed herein), the system 100c detects (702a) a change to ambient light within the interior of the platform, such as the change shown by ambient light indicator 612 in FIG. 6A to the ambient light indicator 612 in FIG. 6B. For example, ambient light optionally refers to light present within the interior space of the platform, such as provided by interior ceiling lights, floor lights, dashboard/instrument cluster lights and/or other lights existing in the interior of the platform produced by the one or more light sources discussed herein. In some embodiments, the electronic device uses one or more light sensors to measure the intensity and/or color tone of ambient light. For example, the electronic device uses multiple light sensors (e.g., positioned at one or more positions within the interior of the platform) to determine variations in ambient light at different locations in the interior of the platform and/or to determine an average ambient light in the interior of the platform. In some embodiments, the electronic device detects the change to ambient light within the interior of the platform while not outputting light in the interior of the platform.

In some embodiments, in response to detecting the change to the ambient light within the interior of the platform (702b), and in accordance with a determination that the change to the ambient light within the interior of the platform is caused by a first change in a light source in an environment external to the interior of the platform, such as moon 618 in FIG. 6B, the electronic device adjusts (702c) the output of light in the interior of the platform in a first manner, such as shown by lights source indicators 614a and 616 in FIG. 6B. In some embodiments, the one or more light sources that output light include lamps, light-emitting diodes, display components, lasers, arrays of light sources, individual light sources, backlight units for display components, lights sources that emit beans of light, and/or other electrically controlled light sources. In some embodiments, the platform includes ambient light sensors or other light-based sensors configured to measure an amount of ambient light within the interior of the platform. In some embodiments, the electronic device includes the ambient light sensors. In some embodiments, the electronic device determines to initiate a process to change the output of light in the interior of the platform based on the measured amount (e.g., measured in lux and/or lumens) of ambient light, the measured intensity of ambient light (e.g., measured in candela (cd)), the measured amount of luminance (e.g., measured in lux (1x)), and/or the measured color temperature (e.g., measured in kelvin) as described herein. For example, the electronic device optionally detects that the measured amount of ambient light within the interior of the platform changed from a first ambient light amount to a second ambient light amount, wherein the first ambient light amount is greater than the second ambient light amount. In some embodiments, the first ambient light amount is less than the second ambient light amount. In some embodiments, the change to the ambient light within the interior of the platform indicates that ambient lighting is too bright or too dark (e.g., the measured amount of ambient light within the interior of the platform is above or below a lighting threshold, such as 20, 40, 60, 80, 100, 150, 200, 250, 300, 350, 400, 600, 800, or 1000 lux) for a user to comfortably read, and/or write. In some embodiments, the first change in light source in the environment external to the interior of the platform is from an external entity located outside of the platform such as the sun, moon, street lamp, a reflective portion of a vehicle or building, flood lights, and/or other external entity that projects light into the interior of the platform. In some embodiments, adjusting the output of light in the interior of the platform in the first manner includes modifying an amount of lighting from a first (initial) amount of lighting to a second amount of lighting that is greater than the first amount of lighting. In some embodiments, the second amount of lighting is less than the first amount of lighting. In some embodiments, adjusting the output of light in the interior of the platform in the first manner includes controlling a sun visor of the platform, electrically-controlled window tints of the platform, or other electrically adjustable component of the platform as will be described in more detail below. It is understood that although the embodiments described herein are directed to modifying an amount of lighting, such lighting adjustments, optionally apply to intensity, luminance, and/or color temperature of lighting as will be described in more detail below. In some embodiments, as described herein and below, adjusting the output of light in the interior of the platform in a first manner is based on a kind or type of change to the ambient light within the interior of the platform, as well as other information (e.g., user activity, operating mode of the platform, and/or location).

In some embodiments, in response to detecting the change to the ambient light within the interior of the platform, and in accordance with a determination that the change to the ambient light within the interior of the platform is caused by a second change in a light source within the interior of the platform, such a light source from laptop 624 in FIG. 6E, the electronic device adjusts (702d) the output of light in the interior of the platform in a second manner different from the first manner, such as shown by the light source indicator 614a in FIG. 6E. In some embodiments, the second change in the light source within the interior of the platform is from the one or more light sources described herein. In some embodiments, the light source within the interior of the platform includes artificial light. For example, artificial light is optionally provided on an interior surface of the platform (e.g., floor lights, ceiling lights, wall lights, reading lights, door lights, and/or dashboard/instrument cluster lights). In another example, artificial light is optionally provided by devices, such as computer displays, mobile displays, wearable displays, television displays, and/or displays of devices different from the electronic device located within the interior of the platform. In some embodiments, the electronic device adjusts the output of light in the interior of the platform in a second manner greater than the first manner (e.g., amount of lighting is increased). In some embodiments, the second manner is less than the first manner (e.g., amount of lighting is decreased). In some embodiments, adjusting the output of light in the interior of the platform in the second manner includes maintaining the output of light from a first light source within the interior of the platform and adjusting the output of light from a second light source within the interior of the platform different from the first light source within the interior of the platform. In some embodiments, adjusting the output of light in the interior of the platform in the second manner includes adjusting the light source within the interior of the platform. In some embodiments, adjusting the output of light in the interior of the platform in the first manner or the second manner includes controlling the respective amount of lighting of the lights sources that are at a predetermined distance (e.g., 5, 10, 12, 14, 16, 18, 20, 40, 60, 80, 100, 120, 140, 160, 180, 200, or 250 centimeters) from the electronic device or a user (optionally equipped with the electronic device) as will be described in more detail below. It is understood that although the embodiments described herein are directed to controlling an amount of lighting, such lighting adjustments, optionally apply to intensity, luminance, and/or color temperature of lighting as will be described in more detail below.

In some embodiments, as described herein and below, adjusting the output of light in the interior of the platform in a second manner is based on a kind or type of change to the ambient light within the interior of the platform, as well as other information (e.g., user activity, operating mode of the platform, and/or location). Automatically adjusting the output of light from one or more light sources within the interior of the platform in response to a change in ambient light within the interior of the platform enables a user to view information and operate devices in an environment with changing ambient lighting conditions, thereby reducing the need for subsequent inputs from a user to manipulate the one or more lights sources which reduces power usage and improves battery life of the electronic device and conserves power of the one or more light sources by automatically adjusting light more quickly and efficiently.

In some embodiments, in response to detecting the change to the ambient light within the interior of the platform (e.g., a change similar to or corresponding to the change to the ambient light within the interior of the platform described above with reference to method(s) 700), and in accordance with a determination that a user within the interior of the platform is interacting with an object, such as the book 622 in FIG. 6C, the electronic device adjusts the output of light in the interior of the platform in a third manner, such as shown by light source indicator 614b in FIG. 6C. In some embodiments, the third manner in which the output of light is adjusted is based on interactions of the user with objects in the platform. For example, the electronic device detects the user reading a book, working on a laptop, engaged in a video call, writing in a journal, searching for an item on furniture or the floor of the platform, or another similar user activity. In some embodiments, the electronic device receives, via one or more camera sensors of the platform and/or of the electronic device, data (e.g., image data) indicative of the user interacting with the object. For example, a pose of the head of the user is within a predetermined distance (e.g., 50, 60, 70, 80, 90, 100 or 200 centimeters) of the object. In another example, a pose of the object is within the predetermined distance of the head of the user.

In some embodiments, the electronic device receives, via a gaze tracking device in communication with the electronic device, data (e.g., image data of the user's eyes) indicative of the user interacting with the object. In some embodiments, the electronic device detects that the gaze of the user is directed to the object for a period of time greater than a threshold period of time (e.g., 0.1, 0.5, 1, 2, 3, 5, 7, 10, 20, 30, or 60 seconds) before adjusting the output of light in the interior of the platform in the third manner. In some embodiments, the object is the electronic device or a second electronic device, different from the electronic device. In some embodiments, the second electronic device has one or more characteristics as the electronic device described above with reference to method(s) 700. In some embodiments, the object is a non-electronic object, such as a book, magazine, notebook, document, journal, and/or other non-electronic object that is read by the user. In some embodiments, adjusting the output of light in the interior of the platform in a third manner is the same as the first manner. In some embodiments, adjusting the output of light in the interior of the platform in a third manner is different from the first manner. For example, the electronic device adjusts the output of light in the interior of the platform in a third manner (e.g., amount, intensity, luminance, and/or color temperature of lighting is increased), different from the first manner (e.g., different from the second and/or other manner described above and/or below) when the electronic device determines that the user is interacting with the object. For example, when the electronic device determines that the user is reading a book, the third manner in which the electronic device outputs light includes a color temperature in a range of 3000 to 6500K (kelvin). In some embodiments, the amount, intensity, luminance, and/or color temperature of lighting is decreased when the electronic device determines that the user is interacting with the object. For example, when the electronic device determines that the user is listening to music, the third manner in which the electronic device outputs light includes a color temperature in a range of 2000 to 3000K so as to facilitate a tranquil environment for the user. In some embodiments, adjusting the output of light in the interior of the platform in the third manner has one or more characteristics of adjusting the output of light in the interior of the platform in the first manner (e.g., in the second and/or other manner).

In some embodiments, the electronic device adjusts the output of light in the interior of the platform in a third manner without changing the first manner, the second manner, and/or other manner such that the third manner in which light is output in the interior of the platform is different from the first manner, the second manner, and/or other manner. For example, changing an amount, magnitude, and/or degree of lighting in the third manner without optionally changing an amount, magnitude, and/or degree of lighting in the first manner, second manner and/or other manner. In some embodiments, the electronic device adjusts the output of light in the interior of the platform in a third manner while changing the first manner, second manner and/or other manner such that the third manner in which light is output in the interior of the platform is the same as the first manner, the second manner and/or other manner or is cumulative to adjusting the output of light in the interior of the platform in the first manner, the second manner and/or other manner. In some embodiments, in accordance with a determination that the user within the interior of the platform is not interacting with the object, the electronic device does not adjust the output of light in the interior of the platform in the third manner. For example, the electronic device outputs light in the interior of the platform in the first, second and/or other manner (e.g., same as before) prior to detecting the change to the ambient light within the interior of the platform. In some embodiments, the electronic device adjusts the output of light without receiving user input corresponding to a request to adjust the output of light. In some embodiments, and as will be described below, the electronic device adjusts the output of light in response to receiving user input corresponding to the request to adjust the output of light. In some embodiments, the electronic device determines that the user is interacting with a second object, different from the object. In response to the determination that the user is interacting with the second object, the electronic device optionally adjusts the output of light in the interior of the platform in a fourth manner, different from the third manner. For example, the second object is optionally a tablet or electronic book reader and to prevent or reduce glare from a display screen (or other light-projecting element) of the tablet, the fourth manner in which the electronic device outputs light includes a luminance in a range of 50-200 lux. In some embodiments, the electronic device adjusts the light generated by the display screen of the table as will be described below. The electronic device optionally adjusts the output of light from the one or more light sources within the interior of the platform using the fourth manner (e.g., and/or the third manner and/or other manner) in accordance with the object with which the user is interacting as will be described below. Automatically adjusting the output of light from one or more light sources within the interior of the platform in accordance with a determination that a user within the interior of the platform is interacting with an object enables a user to view and operate the object in an environment with changing lighting conditions, thereby reducing the need for subsequent inputs from a user to manipulate the one or more lights sources which reduces power usage and improves battery life of the electronic device and conserves power of the one or more light sources by automatically adjusting light more quickly and efficiently.

In some embodiments, in response to detecting the change to the ambient light within the interior of the platform (e.g., a change similar to or corresponding to the change to the ambient light within the interior of the platform described above with reference to method(s) 700), and in accordance with a determination that current time criteria corresponds to an expected change in the light source in the environment external to the interior of the platform, such as sunset 648 in FIG. 6M, the electronic device adjusts the output of the light in the interior of the platform in a third manner different from the second manner, such as shown by color temperature indicator 650 in FIG. 6M. In some embodiments, the third manner in which the output of light is adjusted is based on a current time criteria corresponding to an expected change in the light source in the external environment. For example, sunset, sunrise, dawn, dusk, twilight, or night. In some embodiments, the electronic device adjusts the output of the light in the interior of the platform to enhance the environment external to the interior of the platform (e.g., provide time dependent lighting adjustments that visually accentuates the change in the light source in the environment external to the interior of the platform). For example, enhancing a sunset or sunrise by adjusting a saturation, contrast, and/or brightness of the output of the light in the interior of the platform such that it appears that the sunset or sunrise is within the interior of the platform (e.g., output light in the third manner to match the sunset or sunrise colors from the environment external to the interior of the platform). In another example, when the electronic device determines that the current time criteria corresponds to a period of daytime shortly after sunrise and before sunset when the sun is low on the horizon creating a warm orange glow (e.g., “Golden Hour”), the third manner in which the electronic device outputs light includes a color temperature in a range of 1000 to 4000K so as to match the external environment by providing an orange warm glow within the interior of the platform. In another example, in accordance with a determination that the current time criteria corresponds to a second expected change in the light source in the environment external to the interior of the platform, different from the expected change in the light source, the electronic device adjusts the output of the light in the interior of the platform in a fourth manner different from the third manner. For example, when the electronic device determines that the current time criteria corresponds to a period of daytime shortly before sunrise and after sunset when the sun is below the horizon creating a cool deep blue glow (e.g., “Blue Hour”), the fourth manner in which the electronic device outputs light includes a color temperature in a range of 8000 to 15,000K so as to provide a cool deep blue glow within the interior of the platform that matches the external environment.

In some embodiments, adjusting the output of light in the interior of the platform in the third manner or fourth manner has one or more characteristics of adjusting the output of light in the interior of the platform in the first manner, the second manner, and/or other manner as described above and/or below. In some embodiments, adjusting the output of light in the interior of the platform includes the intensity, luminance, and/or color temperature of lighting. In some embodiments, adjusting the output of light in the interior of the platform includes activating or deactivating particular light source(s). In some embodiments, adjusting the output of light in the interior of the platform includes changing a direction of light emitted from light source(s) (e.g., directed towards the user or away from the user). In some embodiments, adjusting the output of light in the interior of the platform in the third manner, the fourth manner, and/or other manner includes one or more of these lighting adjustments or other lighting adjustments described above and/or below. For example, the third manner and/or other manner in which the electronic device adjusts the output of light in the interior of the platform optionally includes adjusting (e.g., increasing an intensity of) one or more first color values corresponding to the light source in the environment external to the interior of the platform, such as yellow, orange, and red values without changing one or more second color values that do not correspond to the light source in the environment external to the interior of the platform. In some embodiments, adjusting the one or more first color values does not include activating or deactivating particular light source(s), changing a direction of light emitted from light source(s) and/or changing one or more other lighting characteristics such a luminance, for example. In some embodiments, in accordance with a determination that the current time criteria does not correspond to an expected change in the light source in the environment external to the interior of the platform, the electronic device does not adjust the output of light in the interior of the platform in the third manner and/or other manner. For example, the electronic device outputs light in the interior of the platform in the first, second and/or other manner (e.g., same as before) prior to detecting the change to the ambient light within the interior of the platform. Automatically adjusting the output of light from one or more light sources within the interior of the platform in accordance with a determination that the current time criteria corresponds to an expected change in the light source in the environment external to the interior of the platform enables a user to view the external environment within the interior of the platform, thereby reducing potential disorientation of the user being unable to the time of day.

In some embodiments, in response to detecting the change to the ambient light within the interior of the platform (e.g., a change similar to or corresponding to the change to the ambient light within the interior of the platform described above with reference to method(s) 700), and in accordance with a determination that the platform is operating in a first mode (e.g., normal (non-private) mode in which observers exterior to the platform are permitted to readily view the interior of the platform via the display component, or vice versa as described with reference to step(s) 800), the electronic device adjusts the output of light in the interior of the platform in a third manner, such as shown by color temperature indicator 650 in while operating in a normal mode as indicated by privacy mode indicator 636 in FIG. 6M. In some embodiments, the respective manner in which the output of light is adjusted is based on a mode of operation of the platform. For example, and as will be described herein, the electronic device adjusts the output of light to maintain visibility of one or more environmental factors of the external environment to the interior of the platform. For example, when the electronic device determines that the platform is operating in the non-private mode, the third manner in which the electronic device outputs light does not include any distorting colors and/or light patterns to limit the visibility of the one or more environmental factors of the external environment to the interior of the platform and/or prevent external viewers to readily view the interior of the platform, or vice versa. In some embodiments, adjusting the output of light in the interior of the platform in the third manner has one or more characteristics of adjusting the output of light in the interior of the platform in the third manner and/or other manner as described above and/or below. In some embodiments, adjusting the output of light in the interior of the platform in a third manner and/or other manner is based on a determination of whether the change to the ambient light within the interior of the platform satisfies a combination of some or all of the lighting adjustment conditions described herein. For example, the electronic device optionally adjusts the output of light in the interior of the platform in a third manner and/or other manner in accordance with a determination that the platform is operating in a first mode and in accordance with a determination that the current time criteria corresponds to an expected change in the light source in the environment external to the interior of the platform. In another example, the electronic device optionally adjusts the output of light in the interior of the platform in a third manner and/or other manner in accordance with a determination that the platform is operating in a first mode and in accordance with a determination that a user within the interior of the platform is interacting with an object. In some embodiments, the lighting adjustment conditions are associated with an importance value or ranking. For example, adjusting the output of light in the interior of the platform in a third manner and/or other manner in accordance with a determination that a user within the interior of the platform is interacting with an object is optionally prioritized over adjusting the output of light in the interior of the platform in a third manner and/or other manner in accordance with a determination that the platform is operating in a first mode.

In some embodiments, adjusting the output of light in the third manner and/or other manner in accordance with a determination that the platform is operating in a first mode is optionally prioritized over adjusting the output of light in the third manner and/or other manner in accordance with a determination that a user within the interior of the platform is interacting with an object. Other prioritization schemes are contemplated with respect to other lighting adjustment conditions described above and/or below. In some embodiments, the importance value or ranking is automatically determined by the electronic device without user input. In some embodiments, the importance value is set by a user of the electronic device and/or the user within the interior of the platform. In some embodiments, the lighting adjustment conditions are associated with a predetermined target amount of illumination in the interior of the platform. For example, when the electronic device determines that adjusting the output of light in the interior of the platform in a third manner and/or other manner results in meeting or satisfying the predetermined target amount of illumination, the electronic device does not adjust the output of light in the interior of the platform in a third manner and/or other manner (e.g., beyond the predetermined target amount of illumination).

In some embodiments, in response to detecting the change to the ambient light within the interior of the platform, and in accordance with a determination that the platform is operating in a second mode (e.g., privacy mode in which observers exterior to the platform are not permitted to readily view the interior of the platform via the display component, or vice versa as described with reference to step(s) 800), different from the first mode, the electronic device adjusts the output of light in the interior of the platform in a fourth manner different from the third manner (e.g., to maintain privacy), such as shown in by adjusting lights sources 608a, 608b, 606, and 624 while operating in a private mode as indicated by privacy mode indicator 636 in FIG. 6O. In another example, when the electronic device determines that the platform is operating in the privacy mode, the fourth manner in which the electronic device outputs light optionally includes distorting colors and/or light patterns to limit the visibility of the one or more environmental factors of the external environment to the interior of the platform and/or prevent external viewers to readily view the interior of the platform or vice versa (e.g., preserve privacy). In some embodiments, the electronic device displays a visual indication of the one or more environmental factors as described with reference to step(s) 800. In some embodiments, adjusting the output of light in the interior of the platform in the fourth manner has one or more characteristics of adjusting the output of light in the interior of the platform in the second manner and/or other manner as described above and/or below. In some embodiments, the electronic device controls the platform from operating in the first mode to operating in the second mode, and from operating in the second mode to operating in the first mode (optionally without receiving user input to change the operating mode of the platform). Automatically adjusting the output of light from one or more light sources within the interior of the platform in accordance with a determination that the platform is operating in a second mode or a first mode enables a user to view the external environment within the interior of the platform and also preserves user privacy.

In some embodiments, in response to detecting the change to the ambient light within the interior of the platform (e.g., a change similar to or corresponding to the change to the ambient light within the interior of the platform described above with reference to method(s) 700), and in accordance with a determination that a user within the interior of the platform is located within a first threshold distance (e.g., 5, 10, 12, 14, 16, 18, 20, 40, 60, 80, 100, 120, 140, 160, 180, 200, or 250 centimeters) from the one or more light sources, the electronic device adjusts the output of light in the interior of the platform in a third manner, such as adjusting light source 608b in FIG. 6C. In some embodiments, when the electronic device detects that the user has a first location relative to the interior of the platform, the electronic device adjusts the output of light in a third manner or other manner as described above and/or below. In some embodiments, when the electronic device detects that the user has a second location relative to the interior of the platform, different from the first location, the electronic device adjusts the output of light in a manner different from the manner associated with the first location. In some embodiments, and as will be described herein, the electronic device considers whether the respective location of the user relative to the interior of the platform is within the threshold distance from the one or more light sources or farther than the threshold distance from the one or more light sources.

In some embodiments, in response to detecting the change to the ambient light within the interior of the platform, and in accordance with a determination that a user within the interior of the platform is located farther than the first threshold distance (e.g., described above) from the one or more light sources, the electronic device adjusts the output of light in the interior of the platform in a fourth manner, different from the third manner, such as shown by light source indicator 614b in FIG. 6B. In some embodiments, the third manner or the fourth manner in which the output of light is adjusted is based on respective locations of the one or more light sources relative to a location of a user. For example, when the electronic device determines that the user within the interior of the platform is located within the first threshold distance from the one or more light sources, the third manner in which the electronic device outputs light optionally includes modifying an amount of lighting (and/or intensity, luminance, color temperature and/or other characteristic of lighting) of the one or more light sources that are located within the first threshold distance from the user by a first amount, degree, or level greater than and/or different from an amount, degree, or level of lighting associated with the one or more light sources that are located farther than the first threshold distance from the user. In another example, when the electronic device determines that the user within the interior of the platform is located farther than the first threshold distance from the one or more light sources, the fourth manner in which the electronic device outputs light optionally includes little to no adjustments or modifications to the output of light from the one or more light sources. Accordingly, the electronic device optionally adjusts particular light sources located close to (e.g., within the first threshold distance from) the user more than the electronic device adjusts light sources located farther than the threshold distance from the user. In some embodiments, adjusting the output of light in the interior of the platform in the third manner, the fourth manner, and/or other manner is based on a determination of whether the change to the ambient light within the interior of the platform satisfies a combination of some or all of the lighting adjustment conditions and/or prioritization schemes described above and/or below including whether the user is within the predetermined distance from the one or more light sources.

In some embodiments, when the electronic device determines the user moving from a first location that is farther than the first threshold distance from the one or more light sources to a second location that is within the first threshold distance from the one or more light sources, the electronic device adjusts the output of light of the one or more lights sources located within the first threshold distance from the user (e.g., the one or more lights sources located within the first threshold distance from the user at the second location are activated and are optionally selected to be adjusted in the third manner or other manner, or a combination of manners described herein). For example, when the electronic device detects that the user is within the first threshold distance from a first light source, the electronic device optionally adjusts the output of light from the first light source in a first manner (and/or other manner described above and/or below). In another example, when the electronic device detects that the user if farther than the first threshold distance from a second light source, different from the first light source, the electronic device optionally adjusts the output of light from the second light source in a second manner (and/or other manner as described above and/or below). In some embodiments, the first manner includes an amount of lighting (and/or intensity, luminance, color temperature and/or other characteristic of lighting) greater than and/or different from the second manner associated with the second light source. Automatically adjusting the output of light from one or more light sources in accordance with a determination that a user within the interior of the platform is within the first threshold distance from the one or more lights sources enables a user to view an environment with changing lighting conditions, thereby reducing the need for subsequent inputs from a user to manipulate the one or more lights sources which reduces power usage and improves battery life of the electronic device and conserves power of the one or more light sources by automatically adjusting lighting associated with particular light sources located closer to the user more quickly and efficiently.

In some embodiments, the electronic device is in communication with a display component and one or more input devices, such as display 652 in FIG. 6N, the electronic device displays, via the display component, a user interface element selectable to adjust the output of light in the interior of the platform in a third manner, different from the first manner, such as user interface element 654 in FIG. 6N. In some embodiments, the electronic device has one or more of the characteristics of the display component of method 800. In some embodiments, the one or more input devices include an electronic device or component capable of receiving a user input (e.g., capturing a user input and/or detecting a user input) and transmitting information associated with the user input to the electronic device. Examples of input devices include physical buttons, knobs, handles, and/or switches of the platform or electronic device, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, and/or a motion sensor (e.g., a hand tracking device, a hand motion sensor).

In some embodiments, the user interface element is a user interface of an application, such as a platform control application or a lighting application. In some embodiments, the user interface element includes one or more options that, when selected, cause the electronic device to adjust the output of light in the interior of the platform in a third manner (e.g., in the first, second, and/or other manner) as described above and/or below. In some embodiments, the one or more options include a stepper control to increase or decrease an incremental value of the output of light (e.g., amount, intensity, and/or brightness of lighting). In some embodiments, the one or more options include a slider control to adjust between a minimum and maximum value of the output of light (e.g., amount, intensity, and/or brightness of lighting) and/or a color temperature of the output of light (e.g., from 1000K (warm color temperature) to 15,000K (cool color temperature). In some embodiments, the user interface element includes selection elements or options other than the stepper control or the slider control described herein. In some embodiments, the user interface element that, when selected, causes the electronic device to adjust an overall output of light (e.g., color temperature) from all the one or more light sources instead of each individual light source (e.g., instead of manipulating particular lighting characteristics of each individual light). For example, the electronic device optionally detects selection of the user interface element, and in response, the electronic device adjusts an overall color temperature instead of the one or more particular lighting characteristics. In some embodiments, the user interface element optionally includes buttons or affordances to increase or decrease the color temperature (e.g., more warmth or less warmth). In some embodiments, when the electronic device adjusts the output of light in the first manner or other manner, the electronic device displays the user interface element including one or more lighting values corresponding to the manner in which light is output. In some embodiments, the details of which particular lighting characteristic is adjusted/manipulated (e.g., an indication of the lighting values corresponding to the manner in which light is output) is hidden from the user (e.g., the user interface element does not indicate which particular lighting characteristic is adjusted/manipulated in response to user input directed to the user interface element. In some embodiments, the user interface element includes at least two control options: a first control (e.g., “+”, plus button) that, when selected increases one or more respective lighting values of one or more lighting characteristics; and a second control (e.g., “−”, minus button) that, when selected decreases one or more respective lighting values of one or more lighting characteristics or parameters. In some embodiments, in response to user input directed to the first control (or the second control), the electronic device increases (or decreases) one lighting characteristic or a combination of lighting characteristics that is based on whether the ambient light within the interior of the platform satisfies one, a combination of some, or all of the lighting adjustment conditions and/or prioritization schemes described above and/or below. Providing a user interface element to adjust the output of light from one or more light sources within the interior of the platform enables a user to control the output of light from the one or more light sources in an environment quickly and efficiently which reduces power usage and improves battery life of the electronic device and conserves power of the one or more light sources by providing more efficient interactions between the user and the electronic device.

In some embodiments, in response to detecting the change to the ambient light within the interior of the platform (e.g., a change similar to or corresponding to the change to the ambient light within the interior of the platform described above with reference to method(s) 700), and in accordance with a determination that a user within the interior of the platform is a first user, the electronic device adjusts the output of light in the interior of the platform in a third manner, such as adjusting light source 608a based at least in part on user 610 in FIG. 6B. In some embodiments, in response to detecting the change to the ambient light within the interior of the platform, and in accordance with a determination that the user within the interior of the platform is a second user, the electronic device adjusts the output of light in the interior of the platform in a fourth manner, different from the third manner, such as adjusting light source 608b based at least in part on user 620 in FIG. 6C. In some embodiments, adjusting the output of light in the interior of the platform in the third manner or fourth manner has one or more characteristics of adjusting the output of light in the interior of the platform in the first manner and/or other manner as described above and/or below. In some embodiments, the manner in which the output of light is adjusted is based on the user. For example, a first user optionally prefers (e.g., as indicated by a corresponding first user account) the output of light with a first color temperature such that when the electronic device detects presence of the first user, the third manner in which the output of light is adjusted includes the first color temperature preferred by the first user. In another example, when the electronic device detects a second user (e.g., lighting preferences as indicated by a corresponding user account), the electronic device optionally outputs light with a second color temperature (e.g., fourth manner), warmer or cooler than the first color temperature in accordance with lighting preferences of the second user/account.

In some embodiments, when the electronic device detects presence of both the first user and the second user, the electronic device outputs lights in a fifth manner that is in between (e.g., interpolation of) the third manner and the fourth manner. In some embodiments, the second user is associated with a second user account, different from the first user account. In some embodiments, the second user is associated with a same account as the first user. In some embodiments, the third manner, fourth manner, and/or other manner in which the light is output is based on the user account. In some embodiments, adjusting the output of light in the interior of the platform in the third manner, the fourth manner, and/or other manner is based on a determination of whether the change to the ambient light within the interior of the platform satisfies a combination of some or all of the lighting adjustment conditions and/or prioritization schemes described above and/or below including whether the first user or second user is within the interior of the platform. Automatically adjusting the output of light from one or more light sources in accordance with a determination that a first user or second user is within the interior of the platform enables a user to experience light in a manner suited for or preferred by the user, thereby reducing the need for subsequent inputs from a user to manipulate the one or more lights sources which reduces power usage and improves battery life of the electronic device and conserves power of the one or more light sources by automatically adjusting light in a manner based on the user more quickly and efficiently.

In some embodiments, in response to detecting the change to the ambient light within the interior of the platform (e.g., a change similar to or corresponding to the change to the ambient light within the interior of the platform described above with reference to method(s) 700), and in accordance with a determination that a time of day at the electronic device is a first time of day, the electronic device adjusts the output of light in the interior of the platform in a third manner, such as shown by light source indicators 614a, 614b, and 616 in response to the nighttime time of day in FIG. 6C.

In some embodiments, in response to detecting the change to the ambient light within the interior of the platform, and in accordance with a determination that the time of day at the electronic device is a second time of day, the electronic device adjusts the output of light in the interior of the platform in a fourth manner, different from the third manner, such as shown by light source indicators 614a, 614b, and 616 in response to the daytime time of day in FIG. 6F. In some embodiments, adjusting the output of light in the interior of the platform in the third manner or fourth manner has one or more characteristics of adjusting the output of light in the interior of the platform in the first manner and/or other manner as described above and/or below. In some embodiments, the manner in which the output of light is adjusted is to indicate a particular time of day. For example, when the electronic device detects that the first time of day is early morning, the manner in which the output of light is adjusted includes an amount of lighting (and/or intensity, luminance, color temperature and/or other characteristic of lighting) matching the early morning. In another example, when the electronic device detects that the first time of day is early morning, the manner in which the output of light is adjusted includes an amount of lighting to compensate for the light that is output from the early morning as will be described in more detail below. In another example, when the electronic device detects that the second time of day is mid-day, different from early morning, the manner in which the output of light is adjusted includes an amount of lighting matching the mid-day light (e.g., an intensity, luminance, color temperature and/or other characteristic of lighting different from the lighting associated with the first time of day). In some embodiments, as the time of day progresses from early morning to nighttime, the electronic device, in response to the progression of time from early morning to nighttime, adjusts the output of light to match and/or compensate for light that is output as the time of day progresses from early morning to nighttime such that a user within the platform is provided with a sense of the time of day (optionally without looking to the external environment). For example, the electronic device optionally adjusts the output of light with a first intensity (e.g., to simulate a sunrise) that gradually increases to a full intensity (e.g., to simulate direct sunlight/daytime) and then gradually decreases to an intensity less than the first intensity (e.g., to simulate nighttime). In some embodiments, adjusting the output of light in the interior of the platform in the third manner, the fourth manner, and/or other manner is based on a determination of whether the change to the ambient light within the interior of the platform satisfies a combination of some or all of the lighting adjustment conditions and/or prioritization schemes described above and/or below including the time of day at the electronic device. In some embodiments, adjusting the output of light in the interior of the platform in the third manner, the fourth manner, and/or other manner is performed by the electronic device automatically, without receiving or detecting user input to adjust the output of light. In some embodiments, when the electronic device detects movement of the platform to a first location (or with a first velocity, first acceleration, and/or first direction), the electronic device adjusts the output of light in a third manner or other manner as described above and/or below.

In some embodiments, when the electronic device detects the movement of the platform to a second location (or with a second velocity, second acceleration, and/or second direction), different from the first location (or first velocity, first acceleration, and/or first direction), the electronic device adjusts the output of light in a manner different from the manner associated with movement of the platform to the first location (or with a first velocity, first acceleration, and/or first direction). Automatically adjusting the output of light from one or more light sources in accordance with a determination of the time of day enables a user to experience light in a manner corresponding to the time of day, thereby reducing the need for subsequent inputs from a user to manipulate the one or more lights sources which reduces power usage and improves battery life of the electronic device and conserves power of the one or more light sources by automatically adjusting light in a manner based on the time of day quickly and efficiently.

In some embodiments, adjusting the output of light in the interior of the platform in the first manner includes adjusting the output of light in the interior of the platform in the first manner to correspond to the environment external to the interior of the platform, such as shown by light source indicators 614a, 614b, 616, and 626 in response to the direct sun 628 in FIG. 6F. For example, when the electronic device detects that the environment external to the interior of the platform includes sunlight, the first manner in which the output of light is adjusted optionally includes an amount of lighting (and/or intensity, luminance, color temperature and/or other characteristic of lighting) matching sunlight. For example, if sunlight from the environment includes a first color temperature range (e.g., 4600K-6500K), the electronic device outputs light within the first color temperature range. In another example, when the electronic device detects that the environment external to the interior of the platform includes moonlight, the first manner in which the output of light is adjusted optionally includes an amount of lighting (and/or intensity, luminance, color temperature and/or other characteristic of lighting) matching the moonlight.

In some embodiments, the electronic device outputs light in the first manner to correspond to phases of the moon in the environment external to the interior of the platform. For example, when the electronic device determines the external environment includes a crescent moon, the electronic device outputs light with an amount of lighting (and/or intensity, luminance, color temperature and/or other characteristic of lighting) corresponding to the crescent moon. In some embodiments, the electronic device outputs light with an amount of lighting to compensate for the lighting from the crescent moon as will be described in more detail below (e.g., the first manner in which light is output is greater than the amount of lighting from the crescent moon). In some embodiments, adjusting the output of light in the interior of the platform in the first manner to correspond to the environment external to the interior of the platform is based on a determination of whether the output of light to correspond to the external environment satisfies a combination of some or all of the lighting adjustment conditions and/or prioritization schemes described above and/or below. Automatically adjusting the output of light in the interior of the platform in the first manner to correspond to the environment external to the interior of the platform enables a user to experience light within the interior of the platform in a manner corresponding to the external environment, thereby reducing the need for subsequent inputs from a user to manipulate the one or more lights sources which reduces power usage and improves battery life of the electronic device and conserves power of the one or more light sources by automatically adjusting light in a manner based on the external environment quickly and efficiently.

In some embodiments, in response to detecting the change to the ambient light within the interior of the platform (e.g., a change similar to or corresponding to the change to the ambient light within the interior of the platform described above with reference to method(s) 700), and in accordance with a determination that an architecture of the platform is operating in a first mode, the electronic device adjusts the output of light in the interior of the platform in a third manner, such as shown by color/shade 630a and 630b in FIG. 6G. In some embodiments, the architecture of the platform includes one or more windows of the platform. In some embodiments, the one or more windows are electrically controlled by the electronic device to adjust or set a translucency and/or tint of the one or more windows. In some embodiments, the one or more windows obscure the inside of the platform from the outside of the platform, or vice versa. In some embodiments, the first mode has one or more characteristics as the first mode (e.g., normal, non-private mode) described above and with reference to step(s) 800. In some embodiments, and as described in more detail with reference to step(s) 800, when the one or more windows are operating in the first mode, the electronic device does not adjust or set a tint to obscure the external environment to the interior of the platform. Accordingly, the amount of light from the external environment projecting into the interior of the platform is maintained (e.g., remains unchanged when the architecture of the platform is operating in the first mode). In some embodiments, when the electronic device detects that the one or more windows are operating in the first mode, the third manner in which the electronic device adjusts the output of light includes one or more characteristics of adjusting the output of light in the interior of the platform in the first manner and/or other manner as described above and/or below. In some embodiments, adjusting the output of light in the interior of the platform in the third manner is based on a determination of whether the change to the ambient light within the interior of the platform satisfies a combination of some or all of the lighting adjustment conditions and/or prioritization schemes described above and/or below.

In some embodiments, in response to detecting the change to the ambient light within the interior of the platform, and in accordance with a determination that the architecture of the platform is operating in a second mode, the electronic device adjusts the output of light in the interior of the platform in a fourth manner, different from the third manner, such as adjusting the one or more lights sources 608a, 608b, 606, and 624 while operating in accordance with the mode as indicated by privacy mode indicator 636 in FIG. 6O. In some embodiments, the second mode has one or more characteristics as the second mode (e.g., privacy mode) described above and with reference to step(s) 800. In some embodiments, and as described in more detail with reference to step(s) 800, when the one or more windows are operating in the second mode, the electronic device adjusts or sets a tint to obscure the external environment to the interior of the platform. For example, the one or more windows are optionally opaque or semi-opaque (e.g., at least 50%, 60%, 70%, 80%, 90% or 100% opaque). In some embodiments, when the electronic device detects that the one or more windows are operating in the second mode (e.g., optionally opaque or semi-opaque), the fourth manner in which the electronic device adjusts the output of light includes an increased amount of lighting (and/or intensity, luminance, color temperature and/or other characteristic of lighting) to compensate for a lack of light from the external environment projecting into the interior of the platform due to the one or more windows being optionally opaque or semi-opaque. Accordingly, the fourth manner in which light is output includes the electronic device optionally adjusting the output of light to the amount of lighting (and/or intensity, luminance, color temperature and/or other characteristic of lighting) that would have be present in the interior of the environment prior to the one or more windows operating in the second mode.

In some embodiments, the fourth manner in which light is output includes the electronic device optionally adjusting the output of light to satisfy the predetermined target amount of illumination as described above. In some embodiments, the fourth manner includes one or more characteristics of adjusting the output of light in the interior of the platform in the first manner and/or other manner as described above and/or below, but optionally by a greater amount and/or different level to compensate for the dim ambient light in the interior of the platform caused by the one or more windows operating in the second mode. In some embodiments, the electronic device controls the architecture of the platform from operating in the first mode to operating in the second mode, and from operating in the second mode to operating in the first mode (optionally without receiving user input to change the operating mode of the architecture of the platform). Automatically adjusting the output of light from one or more light sources within the interior of the platform in accordance with a determination that the architecture of the platform is operating in a first mode or a second mode enables a user to view and operate objects in an environment with changing lighting conditions due to architecture of the platform operating in the first mode or second mode, thereby reducing the need for subsequent inputs from a user to manipulate the one or more lights sources which reduces power usage and improves battery life of the electronic device and conserves power of the one or more light sources by automatically adjusting light more quickly and efficiently and also preserves user privacy.

In some embodiments, in accordance with a determination that a first amount of light is leaving the interior of the platform, the electronic device adjusts the output of light in the interior of the platform in a third manner, such as light leaving via the display component 602a and/or 602b in FIG. 6A. In some embodiments, in accordance with a determination that a second amount of light is leaving the interior of the platform, the electronic device adjusts the output of light in the interior of the platform in a fourth manner, different from the third manner, such as shown by light source indicators 614a, 614b, and 616 in FIG. 6B. In some embodiments, the manner in which the output of light is adjusted is based on an amount of light leaving the one or more light sources compared to a total light output by the one or more light sources. For example, when the first amount of light leaving the interior of the platform (e.g., the first amount of light leaving the one or more light sources within the interior of the platform) is greater than the total light output by the one or more light sources, the third manner in which the electronic device adjusts the output of light optionally includes deactivating the one or more light sources located within the first threshold distance (e.g., as described above) from an area in which the first amount of light is leaving the interior of the platform (e.g., the area of the one or more windows described above) so as to minimize the amount of light leaving the interior of the platform.

In some embodiments, the third manner in which the electronic device adjusts the output of light optionally includes activating or increasing the amount of light that is output by one or more lights sources located farther than the first threshold distance from the area in which the first amount of light is leaving the interior of the platform. In another example, when the second amount of light leaving the interior of the platform (e.g., the first amount of light leaving the one or more light sources within the interior of the platform) is less than the total light output by the one or more light sources, the fourth manner in which the electronic device adjusts the output of light optionally includes maintaining the activation of the one or more light sources located within the first threshold distance (e.g., as described above) from an area in which the first amount of light is leaving the interior of the platform (e.g., the area of the one or more windows described above). In some embodiments, the fourth manner in which the electronic device adjusts the output of light optionally includes maintaining the activation or the deactivation of the one or more light sources located farther than the first threshold distance from the area in which the first amount of light is leaving the interior of the platform. In some embodiments, the third manner and/or the fourth manner in which the electronic device adjusts the output of light has one or more characteristics of the first manner, the second manner, or other manner described above and/or below. Automatically adjusting the output of light from one or more light sources within the interior of the platform based on an amount of light leaving the interior of the platform enables a user to view and operate objects in an environment with changing lighting conditions due to light leaving the interior of the platform, thereby reducing the need for subsequent inputs from a user to manipulate the one or more lights sources which reduces power usage and improves battery life of the electronic device and conserves power of the one or more light sources by automatically adjusting light more quickly and efficiently.

In some embodiments, adjusting the output of light in the interior of the platform (e.g., in the first, second, third, fourth; and/or other manner) includes adjusting light generated by the platform, such as light source 608a, 608b, and/or 606. For example, the first manner optionally includes adjusting the output of light generated by one or more light sources of the platform. The one or more light sources as described with reference to method(s) 700. For example, when the platform is a vehicle, the one or more light sources optionally include ceiling lights, floor lights, door lights, instrument/dashboard lighting, and/or display lights from one or more displays integrated with the vehicle. In some embodiments, the electronic device adjusts the output of light generated by the platform without receiving or detecting user input to adjust the light generated by the platform. Automatically adjusting light generated by the platform enables a user to view and operate the electronic device in an environment with changing lighting conditions, thereby reducing the need for subsequent inputs from a user to manipulate the one or more lights sources which reduces power usage and improves battery life of the electronic device and conserves power of the one or more light sources by automatically adjusting light more quickly and efficiently.

In some embodiments, adjusting the output of light in the interior of the platform in the first manner (e.g., in the second, third, fourth; and/or other manner) includes adjusting light generated by one or more second electronic devices, such as device 624 in FIG. 6F. For example, the first manner optionally includes adjusting the output of light generated by the display of one or more second electronic devices. The one or more second electronic devices include one or more same characteristics of the electronic device as described with reference to method(s) 700. In some embodiments, the one or more second electronic devices are located within the interior of the platform. In some embodiments, the one or more second electronic devices are different and/or separate from the electronic device. In some embodiments, the electronic device is in communication with the one or more second electronic devices. In some embodiments, the one or more second electronic devices are different and/or separate from the platform. In some embodiments, the one or more second electronic devices are in communication with the platform. In some embodiments, the one or more second electronic devices are configured to perform operations other than light generation and/or manipulation, such as operations associated with content consumption, editing content, organizing content, and/or generating content. In some embodiments, the electronic device adjusts the light generated by the one or more second electronic devices to reduce glare. For example, the electronic device reduces or increases an amount of lighting (and/or intensity, luminance, color temperature and/or other characteristic of lighting) to overcome glare. In some embodiments, the electronic device adjusts the output of light generated by the one or more second electronic devices without receiving or detecting user input to adjust the light generated by the one or more second electronic devices. Automatically adjusting light generated by the electronic device enables a user to view and operate the electronic device and minimize glare caused by an environment with changing lighting conditions, thereby reducing the need for subsequent inputs from a user to manipulate the one or more lights sources which reduces power usage and improves battery life of the electronic device and conserves power of the one or more light sources by automatically adjusting light more quickly and efficiently.

In some embodiments, adjusting the output of light in the interior of the platform in the first manner (e.g., in the second, third, fourth; and/or other manner) includes adjusting light leaving the interior of the platform, such as light leaving via display component 602a and/or 602b in FIG. 6F. For example, the first manner optionally includes adjusting the light leaving the one or more light sources within the interior of the platform as described above. In some embodiments, adjusting the light leaving the interior of the platform includes adjusting or setting an operating mode of an architecture of the platform (e.g., setting the one or more windows of the platform as private and/or applying a tint to the one or more windows as described above). In some embodiments, the electronic device adjusts the light leaving the one or more light sources within the interior of the platform without receiving or detecting user input to adjust the light generated by the electronic device. Automatically adjusting light leaving the interior of the platform enables a user to view and operate the electronic device in an environment with changing lighting conditions, thereby reducing the need for subsequent inputs from a user to manipulate the one or more lights sources which reduces power usage and improves battery life of the electronic device and conserves power of the one or more light sources by automatically adjusting light more quickly and efficiently.

In some embodiments, adjusting the output of light in the interior of the platform in the first manner (e.g., in the second, third, fourth; and/or other manner) includes adjusting light entering the interior of the platform, such direct sunlight from the sun 628 in FIG. 6F. For example, adjusting light entering the interior of the platform includes light from one or more light sources and/or external objects in the environment external to the interior of the platform as described above, such as the sun, moon, streetlamp, a reflective portion of the platform, flood lights, and/or other external entities that project light into the interior of the platform. In some embodiments, adjusting the light entering the interior of the platform includes adjusting or setting an operating mode of an architecture of the platform (e.g., setting the one or more windows of the platform as private and/or applying a tint to the one or more windows as described above). In some embodiments, the electronic device adjusts the light entering the interior of the platform without receiving or detecting user input to adjust the light entering the interior of the platform. Automatically adjusting light entering the interior of the platform enables a user to view and operate the electronic device in an environment with changing lighting conditions, thereby reducing the need for subsequent inputs from a user to manipulate the one or more lights sources which reduces power usage and improves battery life of the electronic device and conserves power of the one or more light sources by automatically adjusting light more quickly and efficiently.

The order in which the operations in FIG. 7 have been described is exemplary and is not intended to indicate that the described order is the only order in which the operations could be performed. One of ordinary skill in the art would recognize a variety of ways to reorder the operations described herein. It should be noted that details of other processes described herein with respect to other method(s) described herein (e.g., method 800) are also applicable in an analogous manner to method 700 described above with respect to FIG. 7. For example, displaying a visual indication described above with reference to method 700 optionally has one or more of the characteristics of displaying the visual indication of one or more environmental factors with a first, second, or other appearance (e.g., method 800). Additionally, the display component described with reference to method 700 optionally has one or more characteristics of the display component described with reference to method 800. For brevity, these details are not repeated here.

The operations in the information processing methods described above are, optionally, implemented by running one or more functional modules in an information processing apparatus such as general purpose processors (e.g., a as described with respect to FIG. 1) or application specific chips. Further, the operations described above with reference to FIG. 7 are, optionally, implemented by components depicted in FIG. 1.

FIG. 8 is a flow diagram illustrating a method in which an electronic device displays or causes to display a visual indication of one or more environmental factors of the environment external to the interior of the platform. The method 800 is optionally performed at first and/or electronic devices such as system 100c as described above with reference to FIG. 1. Some operations in method 800 are, optionally combined and/or order of some operations is, optionally, changed.

In some embodiments, method 800 is performed at an electronic device (e.g., 670) in communication with a display component included in a platform, such as platform 600a and display components 602a and 602b in FIG. 6H. In some embodiments, the electronic device has one or more of the characteristics of the electronic device of method 700. In some embodiments, the platform has one or more of the characteristics of the platform of method 700. In some embodiments, the display component is a display integrated with (optionally one or more exterior windows or windshields of) a vehicle (e.g., car, bus, truck, airplane, train, boat, or other vehicle configured for transportation of a user), a house, store, or other building for projecting a user interface or causing a user interface to be visible to one or more users.

In some embodiments, while the display component is operating in a first mode (802a), the electronic device facilitates (802b) an environment of the platform that includes one or more environmental factors of the environment to be visible to an interior of the platform, such as pedestrians 632a and buildings 634a in FIG. 6H. In some embodiments, the first mode is a normal (non-private) mode in which exterior observers such as pedestrians, drivers and passengers in vehicles, bicyclists, and/or aerial vehicles are permitted to readily view the interior of the platform through a portion of the display component. For example, in the normal (non-private) mode, the electronic device foregoes adjusting or setting a translucency and/or tint of one or more windows to obscure the inside of the platform from the outside of the platform, or vice versa, as will be described herein. In some embodiments, the environment of the platform includes a representation of a physical environment, a simulated environment, a computer-generated reality, or an extended reality. For example, the environment of the platform is optionally an augmented reality environment or a mixed reality environment that optionally includes virtual objects and/or optionally includes representations of real world objects in the physical world around the platform.

In some embodiments, the environment of the platform is based at least on the physical environment around the platform. For example, the electronic device is able to capture visual information about the environment around the platform (e.g., objects in the environment and/or the size and shape of the objects in the environment) and display visual indications of the objects in the environment as discussed herein. In some embodiments, the electronic device concurrently displays a portion of the physical environment around the platform to the user and the visual indications of the objects in the environment. In some embodiments, the environment of the platform visible to the interior of the platform (e.g., a physical environment around the platform, a portion of the physical environment around the platform, etc.) is passively presented to the user via a partially transparent or translucent display through which the user is able to see at least a portion of the physical environment. In some embodiments, facilitating the environment of the platform that includes the one or more environmental factors of the environment to be visible to the interior of the platform includes controlling how much of the physical environment including the one or more environmental factors is displayed and/or how much of the physical environment including the one or more environmental factors is displayed as passive passthrough a transparent portion or semi-transparent (e.g., less than 50%, 40%, 30%, 20%, 10% or 5% of opacity) of the display component. For example, when the electronic device does not control how much of the physical environment is presented via the display component, the one or more environmental factors of the environment would optionally not be visible to the interior of the platform. The presentation of the physical environment and objects in the physical environment will be described in more detail below. In some embodiments, the one or more environmental factors include pedestrians, drivers and passengers in vehicles, bicyclists, aerial vehicles, and/or other environmental factors described below. In some embodiments, the electronic device detects the one or more environmental factors of the environment using one or more sensors of the platform, such as motion sensors, proximity sensors, light sensors and/or other sensors for detecting the one or more environmental factors in the environment surrounding the platform. In some embodiments, and as will be described herein with respect to method 900, the electronic device initiates display of or controls display of a visual indication of the one or more environmental factors of the environment via the display component.

In some embodiments, the electronic device detects (802c) data indicative of a request for the display component to operate according to a second mode, different from the first mode, such as shown by privacy mode indicator 636 in FIG. 6I. In some embodiments, detecting data indicative of the request for the display component to operate according to the second mode includes detecting user input (e.g., a gaze of the user, a contact on a touch-sensitive surface, actuation of a physical input device of the platform, and/or a voice input from the user) corresponding to the request for the display component to operate according to the second mode. In some embodiments, the second mode is a privacy mode in which the exterior observers are not permitted to readily view the interior of the platform via the display component, or vice versa. For example, in the privacy mode, the electronic device adjusts a translucency and/or tint of one or more windows to obscure the inside of the platform from the outside of the platform.

In some embodiments, in response to detecting the data indicative of the request for the display component to operate according to the second mode (802d), the electronic device displays (802c), via the display component, a visual indication of the one or more environmental factors of the environment, such as visual indication 632b and visual indication 634b in FIG. 6I. For example, a view of the one or more environmental factors of the environment visible through a portion of the display component are optionally overlaid, obscured, and/or replaced by the visual indication. In some embodiments, the electronic device displays the indication of the one or more environmental factors without passive passthrough such that the physical environment is not presented via the display component. Accordingly, the one or more environmental factors of the environment would optionally not be visible to the interior of the platform and the indication of the one or more environmental factors would be visible to the interior of the platform. In some embodiments, the electronic device concurrently displays the indication of the one or more environmental factors as passive passthrough with the physical environment as described herein and below. In some embodiments, the electronic device concurrently displays the indication of the one or more environmental factors in a photorealistic representation of the physical environment of the platform (e.g., video passthrough or virtual passthrough).

In some embodiments, the visual indication of the one or more environmental factors of the environment include an animated or non-animated abstraction of the one or more environmental factors. For example, the electronic device optionally displays abstract textures such as particles, shapes, text, and/or images at a location corresponding to the one or more environmental factors. In some embodiments, the electronic device displays the visual indication of the one or more environmental factors of the environment at different positions/sizes on the display component corresponding to the spatial arrangement of the one or more environmental factors relative to the platform and/or the display component. For example, if a pedestrian is located on a right side of the display component, the electronic device optionally displays the visual indication of the pedestrian on the right side of the display component. In another example, if the pedestrian is located a first distance (e.g. 0.2, 0.4, 0.6, 0.8, 1, 2, 4, 6, 8, or 10 meters) from the platform, the electronic device optionally displays the visual indication with a size smaller than the size of the visual indication if the pedestrian is located closer than the first distance from the platform. In some embodiments, the electronic device optionally displays a blur filter at the location of the one or more environmental factors, such that the visual indication of the one or more environmental factors of the environment appears blurred. Additional characteristics of the visual indication of the one or more environmental factors of the environment will be described below. In some embodiments, the electronic device displays the visual indication of the one or more environmental factors with a first visual appearance (e.g., first degree of clarity, color, and/or brightness) when the display component is operating according to the first mode. In some embodiments, the electronic device displays the visual indication of the one or more environmental factors with a second visual appearance (e.g., second degree of clarity, color, and/or brightness), different from the first visual appearance when the display component is operating according to the second mode. In some embodiments, the visual indication is displayed at a size, position and/or orientation on the display component that corresponds to (e.g., is the same as or similar to (e.g., within 1, 3, 5, 10, 30, or 50% of being the same as) the size, position and/or orientation that the environmental factor itself would have if visible via the display component (e.g., operating in the first mode). In some embodiments, the electronic device controls the display component from operating in the second mode to operating in the first mode, and from operating in the first mode to operating in the second mode. Displaying a visual indication of the one or more environmental factors of the environment of the platform enables a user to view information about the environment while also providing the user with privacy, thereby preserving user privacy while reducing potential disorientation of the user being unable to determine their spatial position in the environment.

In some embodiments, while displaying, via the display component, the visual indication of the one or more environmental factors of the environment, the electronic device detects, via one or more sensors (e.g., one or more sensors similar to or corresponding to the one or more sensors as described with reference to step(s) 800), movement of the one or more environmental factors (e.g., relative to the platform and/or the display component), such as movement of the pedestrians 632a from the left to right as indicated in FIG. 6I to 6J. For example, pedestrians walking, bicyclists biking, vehicles driving, and/or airplanes flying.

In some embodiments, in response to (and/or while) detecting movement of the one or more environmental factors, the electronic device moves the visual indication of the one or more environmental factors of the environment in accordance with the movement of the one or more environmental factors, such as visual indication 632b shown as moving from left to right as shown in FIGS. 6I to 6J. In some embodiments, the visual indication is dynamic. For example, the electronic device optionally moves the visual indication based on the movement of the one or more environmental factors relative to the platform and/or the display component. For example and as described above, the display component is optionally a display integrated with (optionally one or more exterior windows or windshields of) a vehicle or building for projecting a user interface or causing a user interface to be visible to one or more users. Accordingly, when the electronic device detects movement of the one or more environmental factors include pedestrians walking from a left side to a right side (or in any directions) relative to the display component and/or the platform, the electronic device displays, via the display component, the visual indication moving from the left side to the right side (or in any directions) in the user interface of the display component (e.g., in a portion of the display component). In some embodiments, a magnitude, speed, acceleration and/or direction of the movement of the visual indication corresponds to a magnitude, speed, acceleration and/or direction of the movement of the one or more environmental factors. In some embodiments, when the electronic device detects movement of the one or more environmental factors including a first amount of velocity, the electronic device displays, via the display component, the visual indication moving with a second amount of velocity corresponding to the first amount of velocity.

In some embodiments, the electronic device adjusts other characteristics of the visual indication in accordance with the corresponding characteristic of the one or more environmental factors in a similar manner. In some embodiments, when the electronic device detects movement of the one or more environmental factors including a third amount of velocity, different from the first amount of velocity, the electronic device displays, via the display component, the visual indication moving with a fourth amount of velocity corresponding to the third amount of velocity, different from the second amount of velocity. In some embodiments, the visual indication is moved an amount proportional to a velocity (or magnitude and/or direction) of the movement of the one or more environmental factors. In some embodiments, the electronic device detects movement of the one or more environmental factors from a first location to a second location that is farther away from the display component. In accordance with a determination that the second location is more than a threshold distance from the display component, in response to detecting movement of the one or more environmental factors from the first location to the second location, the electronic device ceases to display, via the display component, the visual indication to simulate the one or more environmental factors being beyond a user's eyesight. In some embodiments, while detecting movement of the one or more environmental factors from the first location to the second location, the electronic device displays, via the display component, the visual indication moving from a third location (corresponding to the first location) to a fourth location (corresponding to the second location) and with a visual appearance or display property that appears smaller in size as it moved farther away from the display component until the electronic device ceases to display the visual indication as described herein. In some embodiments, while moving the visual indication, the electronic device visually emphasizes the visual indication relative to other visual indications that are static (e.g., other visual indications corresponding to one or more other environmental factors that are not moving). For example, visually emphasizing the visual indication relative to other visual indications include changing relative sizes, colors, transparency levels, opacity, highlighting, lighting, shadow and/or another display property. In some embodiments, when the electronic device detects that movement of the one or more environmental factors has stopped, the electronic device stops moving the visual indication. Moving a visual indication of the one or more environmental factors of the environment of the platform in response to detecting movement of the one or more environmental factors enables a user to view movement of and information about the one or more environmental factors in the environment while also providing the user with privacy, thereby preserving user privacy while reducing potential disorientation of the user being unable to determine their spatial position in the environment.

In some embodiments, wherein displaying the visual indication of the one or more environmental factors of the environment includes, in accordance with a determination that the one or more environmental factors have a first appearance (e.g., first size, first color, first shape, and/or first location), such as pedestrians 632a in FIG. 6H, displaying the visual indication of the one or more environmental factors with a second appearance based on the first appearance (optionally different from the first appearance), such as shown by visual indication 632b in FIG. 6I. In some embodiments, the electronic device displays visual indications with varying visual appearances, such as a size, color, shape, and/or location that corresponds to the same characteristics of the appearance(s) of the one or more environmental factors. For example, the electronic device displays visual indications with varying visual appearances, such as a size, color, shape, and/or location that closely aligns with the one or more environmental factors. For example, displaying the visual indication with the second appearance optionally includes a second size, a second color, second shape, and/or a second location similar to or corresponding to the first size, the first color, first shape, and/or the first location, respectively. For example, when the one or more environmental factors include a rectangular, cuboidal building, the electronic device optionally displays the visual indication of the building with a rectangular, cuboidal shape. In another example, when the one or more environmental factors include cumulous clouds, the electronic device optionally displays the visual indication of the cumulous clouds with a round shape and white color. In some embodiments, the electronic device displays visual indications with a visual appearance that does not closely align with the one or more environmental factors. For example, displaying the visual indication with the second appearance optionally includes a second size, a second color, second shape, and/or a second location different from the first size, the first color, first shape, and the first location, respectively. For example, when the one or more environmental factors include pedestrians, the electronic device optionally displays the visual indication of the pedestrians with a shape that does not resemble pedestrians, such as a generic rectangular or spherical shape. In some embodiments, the visual indication of the pedestrians or any other environmental factors include abstract representations such as avatars, geometric shapes, point clouds, blurred figures, and/or non-humanoid shapes).

In some embodiments, displaying the visual indication of the one or more environmental factors of the environment includes, in accordance with a determination that the one or more environmental factors have a third appearance different from the first appearance, such as buildings 634a in FIG. 6H, displaying the visual indication of the one or more environmental factors with a fourth appearance (optionally different from the third appearance) based on the third appearance and different from the second appearance, such as visual indication 634b in FIG. 6I. For example, the fourth appearance is optionally different from the second appearance in a corresponding way as described herein. In some embodiments, the electronic device displays contextual information such as a representation of a horizon line to indicate the position and/or location of the visual indication relative to the representation of the horizon line. For example, visual indications of flying objects are optionally above the representation of the horizon line and visual indications of buildings are grounded to the representation of the horizon line. Displaying a visual indication of the one or more environmental factors of the environment of the platform with an appearance that is based on the one or more environmental factors enables a user to view recognize objects in the environment while also providing the user with privacy, thereby preserving user privacy while reducing potential disorientation of the user being unable to determine their spatial position in the environment.

In some embodiments, the visual indication of the one or more environmental factors of the environment is associated with a point of interest or a real-world object, such as visual indication 634b in FIG. 6I associated with buildings 634a in FIG. 6H. For example, the point of interest is optionally a landmark, a restaurant, a hotel, a park, an attraction, a bridge, a building, or any other point of interest. The real-world object is optionally the sun, moon, planets, satellites, clouds, horizon, mountains, hills, trees, bushes, streets, signs, paths, and/or other platforms (e.g., vehicles). In some embodiments, the visual indication of the one or more environmental factors of the environment associated with a point of interest or a real-world object includes a second appearance, a fourth appearance, or other appearance as described above and/or below. In some embodiments, displaying the visual indication of the one or more environmental factors of the environment associated with a point of interest or a real-world object includes one or more characteristics similar to the one or more characteristics of displaying visual indications of one or more environmental factors described above or below. Displaying a visual indication of the one or more environmental factors of the environment of the platform including a point of interest or a real-world object enables a user to identify points of interests and/or real-world objects in the environment while also providing the user with privacy, thereby preserving user privacy while reducing potential disorientation of the user being unable to determine their spatial position in the environment.

In some embodiments, the visual indication of the one or more environmental factors of the environment includes an indication of a respective location in the environment, such as shown by visual indication 640 in FIG. 6L. In some embodiments, the respective location is a destination of navigation instructions, a location of a respective point of interest, and/or a location saved by the user. In some embodiments, while the platform is navigating along a route to a destination, the electronic device displays, using the display component, a visual indication of the route, a visual indication of the destination, a visual indication of a name of a route segment in which the platform is currently navigating (e.g., street name), and/or a visual indication of an upcoming maneuver of the navigation directions (e.g., a description and/or icon of the maneuver type). In some embodiments, the visual indication of the respective location is overlaid on the presentation of the physical environment including the visual indication of the one or more environmental factors as described above. For example, the visual indication of the respective location is optionally displayed to appear overlaid on of the location in the physical environment. In some embodiments, the electronic device receives the respective location from a second electronic device, different from the electronic device. In some embodiments, the second electronic device has one or more characteristics similar or corresponding to the second electronic device described above or below. In some embodiments, the electronic device receives the respective location from a system of the platform, such as a vehicle information and entertainment system (e.g., infotainment system). In some embodiments, when the second electronic device and/or the infotainment system is displaying navigation information (e.g., navigation instructions, a representation of a map, a representation of a route, and/or other navigation content described herein), the electronic device transmits data associated with the indication of the respective location such that the second electronic device and/or the infotainment system displays the indication of the respective location (concurrently) with the navigation information on their respective display components (e.g., at a location on a representation of a map corresponding to the respective location). Displaying a visual indication of the one or more environmental factors of the environment of the platform including a visual indication of a respective location in the environment enables a user to identify their respective location in the environment while also providing the user with privacy, thereby preserving user privacy while reducing potential disorientation of the user being unable to determine their location in the environment.

In some embodiments, the visual indication of the one or more environmental factors of the environment includes a simulation of the sun or a simulation of the moon, such as moon 662 in FIG. 6O. In some embodiments, when physical objects in the environment, such as the sun, moon, stars, and/or or other celestial objects are not visible in the environment, the electronic device displays a simulation of the sun, moon or other celestial body. For example, the electronic device optionally displays the visual indication of the one or more environmental factors of the environment including the simulation of the moon overlaid on the presentation of the physical environment including the visual indication of the one or more environmental factors as described above. For example, the simulation of the moon is optionally overlaid on a presentation of the sky of the physical environment. In some embodiments, the electronic device displays the simulation of the moon including one or more visual characteristics corresponding to one or more visual characteristics of the moon being simulated, such as a position, phase, color, hue, tone, brightness, and/or texture of the moon being simulated. In some embodiments, the simulation of the moon (or sun, or other physical object) is visually emphasized relative to the presentation of the physical environment and/or other visual indications that are displayed. For example, visually emphasizing the simulation of the moon relative to the physical environment and/or other visual indications that are displayed include changing a size, color, brightness, and/or another display property of the simulation of the moon. In some embodiments, the electronic device displays the simulation of the moon with shadows consistent with the moon in the physical environment. Displaying a visual indication of the one or more environmental factors of the environment of the platform including a simulation of the sun or a simulation of the moon in the environment enables a user to view the sun or moon in the environment while also providing the user with privacy, thereby preserving user privacy while reducing potential disorientation of the user being unable to determine their spatial position in the environment.

In some embodiments, the visual indication of the one or more environmental factors of the environment includes a representation of a physical object in the environment, such as moon 662 in FIG. 6O. In some embodiments, the physical object has one or more characteristics similar to or corresponding to the real-world object described above. In some embodiments, the representation of the physical object has one or more characteristics to or corresponding to the simulation of the sun or the simulation of the moon described above. In some embodiments, the electronic device detects that physical objects in the environment and/or visual characteristics of the environment prevent other physical objects to be visible in the environment. For example, such objects (that are partially visible or fully not visible) would optionally be fully visible if the physical objects and/or visual characteristics of the environment preventing visibility were not present in the environment. In some embodiments, when physical objects in the environment are partially visible or fully not visible in the environment, the electronic device displays a representation of the physical object in a portion of the display component corresponding to the respective location of the physical object in the environment. For example, due to a foggy or rainy environment, the sun or moon is optionally not fully visible, such as being obscured from a viewpoint of the platform by one or more other objects in the physical environment. The electronic device optionally detects the sun or moon as partially or not visible, and in response, the electronic device optionally displays a representation of the sun or moon (e.g., displays a simulation of the sun or a simulation of the moon as described above). In some embodiments, the representation of the physical object is optionally overlaid on the presentation of the physical environment as described above. In some embodiments, when the electronic device detects that the physical object is fully or partially visible, the electronic device optionally ceases to display the representation of the physical object and controls the display component to display the physical object in the environment. In some embodiments, the representation of the physical object is visually emphasized relative to the physical environment and/or other visual indications or representations of other physical objects that are displayed.

For example, visually emphasizing the representation of the physical object includes changing a size, color, brightness, and/or another display property of the representation of the physical object. In some embodiments, similar to as described above with reference to moving the visual indication of the one or more environmental factors of the environment in accordance with the movement of the one or more environmental factors, the electronic device moves the representation of the physical object in response to detecting movement of the physical object in the environment. In some embodiments, the electronic device displays, via the display component, the representation of the physical object in a predetermined location. In some embodiments, the electronic device displays, via the display component, the representation of the physical object in a location (or size and/or other visual characteristic) that corresponds a respective location (or size and/or other visual characteristic) of the physical object if the physical object were visible via the display component. Accordingly, the representation of the physical object is visible to users within the platform (despite the physical object being no longer visible due to movement). Displaying a representation of a physical object in the environment enables a user to view a representation of the physical object in the environment while also providing the user with privacy, thereby preserving user privacy while reducing potential disorientation of the user being unable to determine their spatial position in the environment.

In some embodiments, while displaying, via the display component, the visual indication of the one or more environmental factors of the environment, the electronic device detects data indicative of a request for the display component to operate according to the first mode (e.g., data similar to or corresponding to data indicative of a request for the display component to operate according to the second mode described with reference to step(s) 800), such as a normal mode as indicated by privacy mode indication 636 in FIG. 6N.

In some embodiments, in response to detecting the data indicative of the request for the display component to operate according to the first mode, and in accordance with a determination that one or more criteria are satisfied, including a criterion that is satisfied when a physical object included in the environment is not visible to the interior of the platform, the electronic device displays, via the display component, a representation of the physical object, such as representation of the moon 662 in FIG. 6O. In some embodiments, the electronic device changes the display component from operating according to the second mode to operating in the first mode (e.g., from a privacy mode to a normal, non-privacy mode as described with reference to step(s) 800).

In some embodiments, the one or more criteria include a criterion that is satisfied when the environment includes a weather condition indicative of low visibility conditions such as fog, dust, snow, or smog, such that physical objects that would otherwise be visible in the environment are not visible or partially visible because of the weather condition. In some embodiments, in response to the weather condition, the electronic device displays a representation of the physical object that would otherwise be visible in the environment if not for the weather condition. In some embodiments, the representation of the physical object has one or more characteristics of the representation of the physical object described above.

In some embodiments, in response to detecting the data indicative of the request for the display component to operate according to the first mode, and in accordance with a determination that the one or more criteria are not satisfied, the electronic device foregoes displaying, via the display component, the representation of the physical object, such as the representation of the moon 662 in FIG. 6O. For example, the electronic device does not detect a weather condition indicative of low visibility conditions as described herein. Accordingly, the electronic device optionally foregoes displaying, via the display component, the representation of the physical object. In some embodiments, the electronic device facilitates the environment of the platform to include the environment including any physical objects and/or weather conditions in the environment. Displaying a representation of a physical object in the environment that would not be visible due to a weather condition enables a user to view a representation of the physical object in the environment despite low visibility conditions, thereby providing awareness of surrounding environment while reducing potential disorientation of the user being unable to determine their spatial position in the environment.

In some embodiments, the display component includes a portion that is integrated with a window of the platform (e.g., a window including a transparent or partially transparent material that provides visibility from an interior of the platform to an exterior of the platform and/or vice versa), such as shown by display components 602a and 602b in FIG. 6F. In some embodiments, displaying the visual indication of the one or more environmental factors includes the electronic device applying a color to the portion of the display component in accordance with lighting conditions exterior to the platform, such as color/shade 630a and 630b to display components 602a and 602b in FIG. 6G. For example, the display component optionally serves as an electrically adjustable shade for the portion that is integrated with the window of the platform. In some embodiments, the electronic device applies adjustable amounts of color to reflect, transmit, and/or absorb light from the environment that is projected into the interior of the platform. In some embodiments, the lighting conditions exterior to the platform are from one or more light sources, such as the sun, streetlights, and/or other light sources described in method(s) 700 and/or 800. For example, when the electronic device detects a first lighting condition exterior to the platform (e.g., direct sunlight corresponding to a range of 30,000 to 100,000 lux), the electronic device, in response to detecting the first lighting condition, applies a first amount of color to the portion of the display component to shade the interior of the platform. In another example, when the electronic device detects a second lighting condition exterior to the platform, less than the first lighting condition (e.g., overcast daylight corresponding to a range of 500 to 5,000 lux), the electronic device applies a second amount of color less than the first amount of color to the portion of the display component.

In some embodiments, when the electronic device detects the second lighting condition exterior to the platform, the electronic device forgoes applying color to the portion of the display component. In some embodiments, when the electronic device detects a lighting condition less than a threshold amount (e.g., 200, 400, 600, 800, 1,000, 15,000, or 20,000 lux), the electronic device forgoes applying color to the portion of the display component. In some embodiments, applying a color to the portion of the display component in accordance with lighting conditions exterior to the platform includes applying the color to different portions of the display component consistent with movement of the light source from which lighting conditions are derived. For example, when the electronic device detects that the light source (e.g., the sun) moves from a first position to a second position (e.g., from a right portion to a left portion (or any direction) of the display component), the electronic device applies the color in accordance with movement of the light source (e.g., applies color from the right portion to the left portion of the display component). In some embodiments, the portion in which the electronic device applies the color is visually emphasized relative to other portions of the display component. For example, visually emphasizing includes changing an amount of the color, brightness of the color, and/or another display property such as a filter and/or degree of opacity. In some embodiments, the electronic device applies the color to the portion of the display component in accordance with lighting conditions exterior to the platform without receiving or detecting user input to manipulate the display component. Applying a color to the portion of the display component in accordance with lighting conditions exterior to the platform enables a user to view the interior of the platform and avoid glare caused by the lighting conditions exterior to the platform, thereby reducing the need for subsequent inputs from a user to manipulate the display component and/or one or more lights sources within the interior of the platform which reduces power usage and improves battery life of the electronic device.

In some embodiments, displaying the visual indication of the one or more environmental factors of the environment includes, in accordance with a determination that the environment has a first value for a first visual characteristic (e.g., a color, a saturation, a brightness, a tint, a hue and/or other visual characteristic), such as sunset 648 in FIG. 6M, displaying the visual indication with a second value, greater than the first value, for the first visual characteristic, such as indicated by color temperature indicator 650 in FIG. 6M.

In some embodiments, displaying the visual indication of the one or more environmental factors of the environment includes, in accordance with a determination that the environment has a third value for the first visual characteristic different from the first value, such as moonlight from the moon 662 in FIG. 6O, displaying the visual indication with a fourth value, greater than the third value, for the first visual characteristic, such as a simulation of the moon 662 in FIG. 6O. In some embodiments, the electronic device visually enhances the one or more environmental factors (e.g., foliage of trees, waves of the ocean, snow on mountains, wildflowers in a field, sunsets, sunrises, and/or other scenery) by displaying the visual indication of the one or more environmental factors with a color or other visual characteristic described herein with a value greater than a respective value associated with the environment. In some embodiments, the electronic device enhances the one or more environmental factors in order to bring attention to the natural beauty and/or color of the one or more environmental factors. For example, when the environment has a first visual characteristic (e.g., color) with a first value (e.g., green grass), the electronic device optionally displays the visual indication for the green grass with a second value that is greater than the first value such that the electronic device displays, via the display component, a vibrant indication of green grass than would have been displayed with the first value. In another example, when the environment includes the first visual characteristic as described herein (e.g., color) with a third value, different from the first value (e.g., a pink sunset), the electronic device optionally displays the visual indication for the sunset with a fourth value that is greater than the third value such that the electronic device displays, via the display component, the sunset with a more vibrant pink than the pink shade of the real sunset. In some embodiments, the environment includes a second visual characteristic other than color, such as saturation, lighting, tint, or hue, for example and as will be described below. In some embodiments, the electronic device displays the visual indication having a visual characteristic with a value greater than the value of the visual characteristic of the environment without receiving or detecting user input to manipulate the display component. Displaying the visual indication having a visual characteristic with a value greater than the value of the visual characteristic of the environment enables a user to view information about the environment while also providing the user with privacy, thereby preserving user privacy while reducing potential disorientation of the user being unable to determine their spatial position in the environment.

In some embodiments, displaying the visual indication of the one or more environmental factors of the environment includes, in accordance with a determination that the environment has a first value for a second visual characteristic (e.g., a color, a saturation, a brightness, a tint, a hue and/or other visual characteristic) different from the first visual characteristic, displaying the visual indication with a second value, less than the first value, for the second visual characteristic, such as for example, minimizing the appearance of fog 664a in FIG. 6P.

In some embodiments, displaying the visual indication of the one or more environmental factors of the environment includes, in accordance with a determination that the environment has a third value for the second visual characteristic different from the first value, displaying the visual indication with a fourth value, less than the third value, for the second visual characteristic, such as minimizing the amount of direct light/brightness from the sun 628 in FIG. 6F. In some embodiments, the electronic device visually minimizes the one or more environmental factors (e.g., unchanging scenery and/or traffic) by displaying the visual indication of the one or more environmental factors with a brightness or other visual characteristic described herein (e.g., different from the first visual characteristic) with a value less than the respective value associated with the environment. In some embodiments, the electronic device visually minimizes the one or more environmental factors in order to bring attention to or highlight other environmental factors. For example, when the environment has a first visual characteristic (e.g., brightness) with a first value (e.g., traffic), the electronic device optionally displays the visual indication for traffic with a second value that is less than the first value such that the electronic device displays, via the display component, a less prominent indication of traffic than would have been displayed with the first value. Accordingly, other environmental factors such as open lanes and/or alternative routes, for example, are presented in the forefront. In another example, when the environment includes the second visual characteristic as described herein (e.g., brightness) with a third value, less than the first value, the electronic device optionally displays the visual indication for traffic with a fourth value that is less than the third value such that the electronic device displays, via the display component, a lesser prominent indication of traffic than would have been displayed with the third value. In some embodiments, the third value is greater than the first value. In another example, the electronic device visually minimizes the one or more environmental factors in order to provide improved visibility of the environment. For example, if the environment includes one or more environmental factors corresponding to rain and/or fog that optionally decrease visibility of the environment, the electronic device optionally visually minimizes the effects of the rain and/or fog in order to improve the visibility of the environment as described herein. In some embodiments, the electronic device displays the visual indication having a visual characteristic with a value less than the value of the visual characteristic of the environment without receiving or detecting user input to manipulate the display component. Displaying the visual indication having a visual characteristic with a value less than the value of the visual characteristic of the environment enables a user to focus their attention to other information about the environment while also providing the user with privacy, thereby preserving user privacy while reducing potential disorientation of the user being unable to determine their spatial position in the environment.

In some embodiments, while displaying the visual indication of the one or more environmental factors of the environment, in accordance with a determination that a color of light entering the platform from outside the platform is outside of a predefined range of values (e.g., 2000 to 5000K (kelvin)), the electronic device applies a color correction to light inside the platform via the display component, such as shown by light source indicators 614a, 614b, and 616 having a respective magnitude of light in response to moonlight entering the room in FIG. 6C. In some embodiments, light inside the platform is associated with a predefined range of illumination (e.g., color temperature) such that any color of light entering the platform from the outside of the platform (e.g., through the display component) that is outside the predefined range causes the electronic device to apply a color correction to light inside the platform via the display component. For example, the electronic device optionally applies a color temperature value to one or more light sources integrated in the display component and/or one or more light sources that are located within the platform to be within the predefined range of illumination. In another example, the electronic device optionally applies a color to the portion of the display component as described above with reference to applying a color to the portion of the display component in accordance with lighting conditions exterior to the platform, such that the light inside the platform is within the predefined range. In some embodiments, applying a color temperature value to correct the light inside the platform is associated with a predetermined target color temperature in the interior of the platform. For example, when the electronic device determines that adjusting the color temperature value results in meeting or satisfying the predetermined target color temperature, the electronic device does not further apply and/or adjust the color temperature value (e.g., beyond the predetermined target color temperature). In some embodiments, the electronic device considers the color temperature of the interior of the platform including the color temperature of light entering the platform from outside the platform when applying the color temperature value to correct the light inside the platform.

In some embodiments, while displaying the visual indication of the one or more environmental factors of the environment, in accordance with a determination that the color of light entering the platform from outside the platform is within the predefined range of values, the electronic device forgoes applying the color correction to light inside the platform via the display component, such as foregoing adjusting light sources 608a, 608b, and 606 in response to the sunlight from sun 628 in FIG. 6F. In some embodiments, the electronic device applies or forgoes applying the color correction without receiving or detecting user input to manipulate the display component. Applying a color correction to light inside the platform via the display component in response light entering the platform from outside the platform that is outside of a predefined range of values enables a user to view information and operate devices within the platform while also providing the user with privacy, thereby reducing the need for subsequent inputs from a user to manipulate the one or more lights sources which reduces power usage and improves battery life of the electronic device and conserves power of the one or more light sources by automatically adjusting light more quickly and efficiently while also preserving user privacy.

In some embodiments, the visual indication of the one or more environmental factors of the environment is displayed at a location (of the display component) that corresponds to a respective location of the one or more environmental factors in the environment, such as visual indication 632b in FIG. 6J. For example and as described above, the display component is optionally a display integrated with (optionally one or more exterior windows or windshields of) a vehicle or building for projecting a user interface or causing a user interface to be visible to one or more users. Accordingly, when the electronic device detects that the one or more environmental factors is located to the right (or other direction) of the platform (e.g., display component), the electronic device optionally displays, via the display component, the visual indication in a right portion of the display component. In another example, when the electronic device detects that the one or more environmental factors is located a first distance (e.g. 0.2, 0.4, 0.6, 0.8, 1, 2, 4, 6, 8, or 10 meters) from the platform, the electronic device optionally displays the visual indication with a size smaller than the size of the visual indication if the one or more environmental factors are located closer than the first distance from the platform. In some embodiments, and as described above, the electronic device moves the visual indication in accordance with movement of the one or more environmental factors in the environment. Displaying a visual indication of the one or more environmental factors of the environment of the platform at a location corresponding to the one or more environmental factors in the environment enables a user to view the location of the one or more environmental factors in the environment while also providing the user with privacy, thereby preserving user privacy while reducing potential disorientation of the user being unable to determine their spatial position in the environment.

In some embodiments, while displaying, via the display component, the visual indication of the one or more environmental factors of the environment, the electronic device detects data indicative of a request for the display component to operate according to the first mode (e.g., data similar to or corresponding to data indicative of a request for the display component to operate according to the second mode described with reference to step(s) 800), such as shown by privacy indicator 636 in FIG. 6H.

In some embodiments, in response to detecting the data indicative of the request for the display component to operate according to the first mode, the electronic device ceases to display the visual indication of the one or more environmental factors of the environment and facilitates the environment of the platform to include the one or more environmental factors of the environment to be visible to the interior of the platform, such as shown in FIG. 6H where the pedestrians 632a are visible via display component 602a. The electronic device changes the display component from operating according to the second mode to operating in the first mode (e.g., from a privacy mode to a normal, non-privacy mode as described with reference to step(s) 800). In some embodiments, facilitating the environment of the platform to include the one or more environmental factors of the environment to be visible to the interior of the platform has one or more same characteristics or corresponds to facilitating an environment of a platform that includes one or more environmental factors of the environment to be visible to an interior of the platform as described with reference to step(s) 800. In some embodiments, the electronic device facilitates the environment of the platform to include the one or more environmental factors of the environment to be visible to the interior of the platform without receiving or detecting data indicative of the request for the display component to operate according to the first mode. Changing from operating in a second mode including displaying a visual indication of the one or more environmental factors of the environment of the platform to operating in a first mode including facilitating the environment of the platform to include the one or more environmental factors of the environment to be visible to the interior of the platform in response to receiving data indicative of the request for the display component to operate according to the first mode enables a user to view information about the environment, thereby providing awareness of the environment while reducing potential disorientation of the user being unable to determine their spatial position in the environment.

In some embodiments, facilitating the environment of the platform to include the one or more environmental factors of the environment to be visible to the interior of the platform includes the electronic device adjusting light output in the interior of the platform, such as from one or more lights sources 608a, 608b, and/or 606 in FIG. 6F. For example, the electronic device optionally adjusts the output of light from one or more light sources within the interior of the platform in response to a change in ambient caused by the environment external to the interior of the platform as described with reference to method 700. In some embodiments, the electronic device adjusts light output in the interior of the platform without receiving or detecting user input to adjust the light output in the interior of the platform. Adjusting the light in the interior of the platform enables a user to view information and operate devices in an environment with changing lighting conditions caused by operating a display component in different modes, thereby reducing the need for subsequent inputs from a user to manipulate one or more lights sources which reduces power usage and improves battery life of the electronic device.

The order in which the operations in FIG. 8 have been described is exemplary and is not intended to indicate that the described order is the only order in which the operations could be performed. One of ordinary skill in the art would recognize a variety of ways to reorder the operations described herein. It should be noted that details of other processes described herein with respect to other method(s) described herein (e.g., method 700) are also applicable in an analogous manner to method 800 described above with respect to FIG. 8. For example, the operation of adjusting light output in the interior of the platform in a first, second, or other manner described above with reference to method 700 optionally has one or more of the characteristics of adjusting light output in the interior of the platform (e.g., method 800). Additionally, the platform operating in a first mode described with reference to method 700 optionally has one or more characteristics of the first mode described with reference to method 800. For brevity, these details are not repeated here.

The operations in the information processing methods described above are, optionally, implemented by running one or more functional modules in an information processing apparatus such as general purpose processors (e.g., a as described with respect to FIG. 1) or application specific chips. Further, the operations described above with reference to FIGS. 7 and 8 are, optionally, implemented by components depicted in FIG. 1.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

1. A method comprising:
at an electronic device in communication with a platform:
while outputting light in an interior of the platform, using one or more light sources, detecting a change to ambient light within the interior of the platform;
in response to detecting the change to the ambient light within the interior of the platform:
in accordance with a determination that the change to the ambient light within the interior of the platform is caused by a first change in a light source in an environment external to the interior of the platform, adjusting the output of light in the interior of the platform in a first manner; and
in accordance with a determination that the change to the ambient light within the interior of the platform is caused by a second change in a light source within the interior of the platform, adjusting the output of light in the interior of the platform in a second manner different from the first manner.

2. The method of claim 1, further comprising, in response to detecting the change to the ambient light within the interior of the platform:
in accordance with a determination that a user within the interior of the platform is interacting with an object, adjusting the output of light in the interior of the platform in a third manner.

3. The method of claim 1, further comprising, in response to detecting the change to the ambient light within the interior of the platform:
in accordance with a determination that current time criteria corresponds to an expected change in the light source in the environment external to the interior of the platform, adjusting the output of the light in the interior of the platform in a third manner different from the second manner.

4. The method of claim 1, further comprising, in response to detecting the change to the ambient light within the interior of the platform:
in accordance with a determination that the platform is operating in a first mode, adjusting the output of light in the interior of the platform in a third manner; and
in accordance with a determination that the platform is operating in a second mode, different from the first mode, adjusting the output of light in the interior of the platform in a fourth manner different from the third manner.

5. The method of claim 1, further comprising, in response to detecting the change to the ambient light within the interior of the platform:
in accordance with a determination that a user within the interior of the platform is located within a first threshold distance from the one or more light sources, adjusting the output of light in the interior of the platform in a third manner; and
in accordance with a determination that a user within the interior of the platform is located further than the first threshold distance from the one or more light sources, adjusting the output of light in the interior of the platform in a fourth manner, different from the third manner.

6. The method of claim 1, wherein the electronic device is in communication with a display component and one or more input devices, the method further comprising:
displaying, via the display component, a user interface element selectable to adjust the output of light in the interior of the platform in a third manner, different from the first manner.

7. The method of claim 1, further comprising in response to detecting the change to the ambient light within the interior of the platform:
in accordance with a determination that a user within the interior of the platform is a first user, adjusting the output of light in the interior of the platform in a third manner; and
in accordance with a determination that the user within the interior of the platform is a second user, adjusting the output of light in the interior of the platform in a fourth manner, different from the third manner.

8. The method of claim 1, further comprising in response to detecting the change to the ambient light within the interior of the platform:
in accordance with a determination that a time of day at the electronic device is a first time of day, adjusting the output of light in the interior of the platform in a third manner; and
in accordance with a determination that the time of day at the electronic device is a second time of day, adjusting the output of light in the interior of the platform in a fourth manner, different from the third manner.

9. The method of claim 1, wherein adjusting the output of light in the interior of the platform in the first manner includes adjusting the output of light in the interior of the platform in the first manner to correspond to the environment external to the interior of the platform.

10. The method of claim 1, further comprising in response to detecting the change to the ambient light within the interior of the platform:
in accordance with a determination that an architecture of the platform is operating in a first mode, adjusting the output of light in the interior of the platform in a third manner; and
in accordance with a determination that the architecture of the platform is operating in a second mode, adjusting the output of light in the interior of the platform in a fourth manner, different from the third manner.

11. The method of claim 1, wherein adjusting the output of light in the interior of the platform in the first manner includes:
in accordance with a determination that a first amount of light is leaving the interior of the platform, adjusting the output of light in the interior of the platform in a third manner; and
in accordance with a determination that a second amount of light is leaving the interior of the platform, adjusting the output of light in the interior of the platform in a fourth manner, different from the third manner.

12. The method of claim 1, wherein adjusting the output of light in an interior of the platform includes adjusting light generated by the platform.

13. The method of claim 1, wherein adjusting the output of light in an interior of the platform in the first manner includes adjusting light generated by one or more second electronic devices.

14. The method of claim 1, wherein adjusting the output of light in the interior of the platform in the first manner includes adjusting light leaving an interior of the platform.

15. The method of claim 1, wherein adjusting the output of light in the interior of the platform in the first manner includes adjusting light entering an interior of the platform.

16. An electronic device comprising:
one or more processors;
memory; and
one or more programs, wherein the one or more programs are stored in the memory and configured to be executed by the one or more processors, the one or more programs including instructions for:
while outputting light in an interior of a platform, using one or more light sources, detecting a change to ambient light within the interior of the platform;
in response to detecting the change to the ambient light within the interior of the platform:
in accordance with a determination that the change to the ambient light within the interior of the platform is caused by a first change in a light source in an environment external to the interior of the platform, adjusting the output of light in the interior of the platform in a first manner; and
in accordance with a determination that the change to the ambient light within the interior of the platform is caused by a second change in a light source within the interior of the platform, adjusting the output of light in an interior of the platform in a second manner different from the first manner.

17. A non-transitory computer readable storage medium storing one or more programs, the one or more programs comprising instructions, which when executed by one or more processors of an electronic device, cause the electronic device to perform a method comprising:
while outputting light in an interior of a platform, using one or more light sources,
detecting a change to ambient light within the interior of the platform;
in response to detecting the change to the ambient light within the interior of the platform:
in accordance with a determination that the change to the ambient light within the interior of the platform is caused by a first change in a light source in an environment external to the interior of the platform, adjusting the output of light in the interior of the platform in a first manner; and
in accordance with a determination that the change to the ambient light within the interior of the platform is caused by a second change in a light source within the interior of the platform, adjusting the output of light in an interior of the platform in a second manner different from the first manner.

18.-36. (canceled)
